(19) United States
(12) Patent Application Publication
(10) Pub. No.: US 2008/0069673 A1
(43) Pub. Date: Mar. 20, 2008

(54) Assembly Plant

(76) Inventor: Shingo Tsujihama, Tokyo (JP)

Correspondence Address: SMITH, GAMBRELL & RUSSELL, 1130 CONNECTICUT AVENUE, N.W., SUITE 1130, WASHINGTON, DC, 20036, US

(21) Appl. No.: 11/629,865

(22) PCT Filed: Jun. 17, 2005
(86) PCT No.: PCT/JP05/11147

§ 371 Date: Dec. 18, 2006

(30) Foreign Application Priority Data
Jun. 18, 2004 (JP) 2004-181419
Sep. 8, 2004 (JP) 2004-261187
Sep. 13, 2004 (JP) 2004-264894

(51) Int. Cl. B23P 21/00; B62D 65/18; B66C 13/22; B66C 13/48

(52) U.S. Cl. 414/353; 198/678.1; 29/712; 29/714

(57) ABSTRACT

A structure conveying an article undergoing an assembly operation by conveyor and providing a module or a component from a module supply area provided along that conveyor to a position of the article undergoing conveyance using a crane, wherein supply of the module or the component is performed in a rational manner. A motion direction and a speed of a hoist carrying a module or an article in a space above the conveyor are synchronized with a motion direction and a speed of the article being conveyed by the conveyor. Specifically, a rail from which the hoist is suspended and disposed over the conveyor has a movable construction, and using a motion of this rail and a motion of the hoist, the motion direction and speed of the hoist is synchronized with the motion direction and speed of the article.

### TECHNICAL FIELD

The present invention relates to equipment and an assembly operation method of an assembly plant assembling an automobile and other articles. The present invention is used to provide a member to an article to be subjected to assembly when the article is in a state of motion as a result of an action of a conveyor. Although developed in particular for usage in the new format of vehicle assembly (commonly referred to as the “sundial” in a test plant) disclosed by the application of the present invention in patent document 1, the present invention is not limited to usage in vehicle assembly, and widespread usage thereof in other applications is also possible.

### BACKGROUND ART

The applicant of the present invention disclosed a new format for a vehicle assembly plant in patent document 1. This represents a fundamental reformation of the format of a conventionally implemented plant having a vehicle manufacturing line. That is to say, the conventional vehicle assembly plant is accepted as having originated with the Ford Model T manufacturing plant established in 1907 (see non-patent document 1) and is a format that has been widely and continually implemented. Here, vehicle assembly is performed by introducing a vehicle-use frame from a start end of a long manufacturing line of a straight-line shape, and while moving this vehicle-use frame in accordance with a designated takt timer, by supplying an axle, an engine, a transmission, various component units, and a cabin, etc. from a side of this manufacturing line such that a level of completion becomes successively higher upon passage through each process.

In contrast to this, the invention disclosed in patent document 1 provides a disc-shaped rotating assembly stand whereupon a single vehicle (or two or three vehicles) is mounted, and while slowly rotating that assembly stand about a central axis of the disc thereof, performs vehicle assembly on that assembly stand. Furthermore, a module supply area is setup around this rotating assembly stand on a floor surface and in a substantially radial pattern from a center of rotation of this rotating assembly stand, and as operations on the rotating assembly stand progress, a necessary component and module, assembled from a plurality of components into a single form, are supplied from this module supply area onto the rotating assembly stand.

Repetitive testing and improvement was carried out with respect to this operation format over several months. Results thereof showed that, assembly of a standard truck can be executed to a specific level while rotating this rotating assembly stand once over several tens of minutes, and the completed vehicle becomes able to leave the rotating assembly stand under its own propulsion.

The greatest advantage of this assembly method is an economic effect of reducing a quantity of work-in-process while also reducing a period of retention as work-in-progress. That is to say, an incomplete vehicle remains on an assembly line for n times (corresponding to a number of processes, where, for example, n=30) an operating duration for one process (for example, 15 minutes) in a conventional assembly line method, all of which is booked as work-in-progress for the purpose of accounting. In contrast to this, in a method using a rotating assembly stand, one vehicle per plant is booked as a work-in-progress quantity, and an assembly work duration per vehicle is several tens of minutes (or in more specific terms, approximately 1 hour). Furthermore, by adopting such a manufacturing format, manufacturing-line space can be reduced, a relocation distance of components and modules can be shortened, the majority of large items of equipment and devices become unnecessary, a degree of flexibility in production management increases, and other similar benefits can be realized.
Patent document 1: JP2004-066516A, PTC/JP2004/003135 (undisclosed as of the filing of the present application)
Non-patent document 1: Encyclopedia Britannica, Henry Ford section

### DISCLOSURE OF INVENTION

### Problem to be Solved by the Invention

During test vehicle-assembly operations using a rotating assembly stand as explained above, it was leaned that a crane device and a peripheral device thereof, setup around the rotating assembly stand for supplying a module or component from a module supply area as an assembly operations progresses, require optimization of some manner. The term “crane device” as used herein is defined as an item of equipment comprising a hoist raising and conveying an article, and a rail whereon the hoist runs.

An incomplete vehicle undergoing an assembly operation as explained above is mounted at a center of the rotating assembly stand and slowly rotates. A rotational velocity thereof is, for example, several degrees per minute (or to illustrate more specifically, 6 degrees/min). This illustrated numerical value need not necessarily be controlled so as to remain constant throughout that process, and modification of the rotational velocity in accordance with a program at each period of time designated based on a nature of the operation is also carried out.

Furthermore, a necessary module (or component) is supplied to this rotating assembly stand from the surroundings thereof as required in accordance with the progress of the assembly operation. At this time, a worker operates a hoist suspended from a rail provided on a ceiling of the plant, and at a suitable time, picks up a required module having been prepared in a module supply area, and while providing assistance, the worker conveys this to a position above the rotating assembly stand and supplies this to a mounting position of the vehicle undergoing the assembly operation.

It should be noted that the term “module” as used in this specification is a general term including an engine module, an axle module, and other compound articles assembled into a specific format from a plurality of components, in addition to a fuel tank, a battery, a seat, and other unit components.

In an assembly plant, a horizontal conveyance direction of a hoist used for hoisting up and transportation in a desired direction of a module inevitably corresponds to a direction of a rail provided on the ceiling of the plant and whereupon the hoist runs. It was learned from experience in trial and test assembly operations using a rotating assembly stand that constructions wherein this horizontal conveyance direction is fixed can be extremely inconvenient. In practical terms, it is necessary to temporarily stop a rotation of the rotating assembly stand in order to move a component or a module transported by the hoist to the vicinity of a vehicle frame undergoing an assembly operation. Temporarily stopping the rotation of the rotating assembly stand implies that the assembly operation is temporarily halted. If stopping of the rotation of the rotating assembly stand in an arbitrary manner were to be permitted, arbitrary halting of the assembly operation must also be permitted, giving rise to a cause of reduced operating efficiency.

The following will explain this in more detail: A vehicle undergoing an assembly operation is rotating slowly together with a rotating assembly stand. When a horizontal conveyance direction of a hoist supplying a module or component to this is fixed, the hoist cannot accurately convey the module or component to an appropriate position in the vicinity of the vehicle undergoing assembly. For example, during an operation of slowly lowering an engine module onto a vehicle frame, although the relocation direction of the hoist is a fixed linear direction, the vehicle frame is moving slowly on a circumference. It was confirmed that, when the rotating assembly stand is in a rotating condition, a configuration wherein the relocation direction of the hoist can track the rotation of the rotating assembly stand and maintain a fixed angle with respect to the vehicle undergoing assembly on the rotating assembly stand is preferable.

Furthermore, when supplying a plurality of modules from a module supply area onto the rotating assembly stand, it is necessary to allow for a slight amount of leeway in the supply timing thereof. That is to say, an operation on a vehicle undergoing assembly on the rotating assembly stand does not necessarily proceed strictly in line with a design in terms of an operating duration thereof, and the operation may proceed quickly or may be delayed. In accordance with this, it is favorable that settings be configured so as to allow even for a situation wherein the supply of a module from a module supply area deviates slightly from the designed timing and occurs either early or late. This also constitutes an advantage of using this rotating assembly stand. It was confirmed that, for this purpose, a hoist for conveying a module should be configured so as to be capable of becoming temporarily independent of the angle of rotation of the rotating assembly stand and picking up the module.

That is to say, it is an object of the present invention to provide, in a vehicle assembly plant performing an assembly process on a vehicle on a slowly rotating rotating assembly stand, a crane device of a reasonable format for supplying a module or a component to this rotating assembly stand and a peripheral device thereof. It is an object of the present invention to provide an auxiliary device for reducing the man-hours required for a vehicle assembly operation on the rotating assembly stand. It is an object of the present invention to provide a device for supplying an article, without breakage thereof, to a precise position with respect to a vehicle undergoing an assembly operation on the rotating assembly stand. It is an object of the present invention to provide a plant apparatus capable of supplying a module or component for supply to this rotating assembly stand from a direction with respect to a vehicle on the rotating assembly stand and undergoing an assembly operation that is convenient for operation, while maintaining that direction over a necessary duration and while also retaining a rotation condition of the rotating assembly stand. It is an object of the present invention to provide a plant apparatus capable of maintaining a constant speed of operation progress by rotating the rotating assembly stand at a constant speed. It is an object of the present invention to provide a crane device capable of supplying a module or component onto the rotating assembly stand and of responding flexibly even in a situation wherein an event of some kind occurs and an operation on the rotating assembly stand does not proceed in line with a scheduled time.

Furthermore, it was confirmed that the present invention can be used in plants manufacturing various mass-produced articles. Conventionally, vehicle manufacturing plants employ a so-called takt system wherein conveyors are moved through individual distances corresponding to each individual process, and the motion thereof is halted at a timing at which workers access an article to be operated upon. However, it is believed that, by using the present invention, assembly operations in many of those operating steps will be possible with a conveyor in a state of continuous motion. If assembly operations are carried out with a conveyor in a state of continuous motion, a distance interval for a step disposed along the conveyor may be set arbitrarily. That is to say, a configuration wherein the conveyor is driven at a constant speed, steps with a short operating duration have a short step range, and steps with a long operating duration have a long step range can be realized.

Furthermore, a conveyor provided within a plant may be used only for conveyance of half products being worked upon within the plant. An operation performed in such a plant takes the form of half products conveyed by the conveyor being moved temporarily from the conveyor onto a fixed stand, and after execution of a certain operation, being returned to the conveyor and delivered to a next step. It is believed that, by using the device of the present invention, many of those step operations can be executed with the half product remaining mounted on the conveyor. That is to say, the present invention can be put to widespread use in plants supplying components and materials and performing product assembly operations while conveying articles to be operated upon using a conveyor.

That is to say, in addition to the above objects, it is an object of the present invention to provide a module to an article to be operated upon while the article is being slowly conveyed. It is an object of the present invention to provide a method and device not requiring temporary halting of the running of a conveyor at a timing of supply of a module. It is an object of the present invention to provide a control method and device preventing unintentional collision between a module to be supplied and an article being assembled.

### Means for Solving Problem

A first aspect of the present invention provides an assembly plant comprising a conveyor conveying an article undergoing an assembly operation, a module assembly area supplying a module (comprising a component or a material) to the article being conveyed by this conveyor, and a hoist transporting the module to be supplied from this module supply area along the conveyor to a position of the article in motion, and providing a means whereby a direction of motion and a speed of the hoist above the conveyor is synchronized with a direction of motion and a speed of the article conveyed by the conveyor. Here, the phrase “a direction of motion and a speed of an article A is synchronized with a direction of motion and a speed of an Article B” means that the two articles A and B are each controlled so as to move in the same direction of motion and at the same speed of motion with respect to an absolute space at one notable point in time. Although mutual connection in a rigid, mechanical manner is one specific example of how such a condition can be achieved for Article A and Article B, the device of the present invention is not limited to mechanical means, and such a condition can also be achieved using a configuration means comprising a plurality of mechanical means and electrical means.

That is to say, in the device of the present invention, synchronizing of a hoist for supplying a module with an article being conveyed by a conveyor with a motion of this conveyor causes the relative positioning of the “article” and the “hoist” to become fixed, and the module conveyed by the hoist can be accurately moved to a desired position of the article being conveyed by the conveyor in accordance with a manual operation of a worker or the like.

A configuration comprising a first rail wherefrom the hoist provided above the conveyor is suspended and capable of moving that hoist in synchrony with a motion of that conveyor and a fixed second rail supporting this first rail so as to be movable can be used as the synchronizing means. Furthermore, a third rail capable of passing the hoist reciprocally between the first rail provided in a fixed manner above the module supply area and the third rail and a connecting means connecting the first rail and the third rail in a condition allowing passage of the hoist therebetween can also be included.

The connecting means can comprise a fourth rail capable of passing the hoist reciprocally between the first rail and the fourth rail and between the third rail and the fourth rail and a supporting means supporting this fourth rail so as to be movable in a space between the first rail and the third rail.

Rather than use the fourth rail, the connecting means can also comprise a means for stopping the first rail in a condition wherein an end section of the first rail opposes an end section of the third rail so as to enable the hoist to pass reciprocally and directly between the first rail and the third rail. In such a case, it is preferable that the means for stopping comprise a mechanical means of connection between an end section of the first rail and an end section of the third rail.

It is desirable that the means of connection comprises support members having a pair-type structure and firmly supporting each of a pair of rails having mutually opposing end sections (the first rail and a fifth rail and a fourth rail and the third rail when using a fourth rail; the first rail and the third rail when not using a fourth rail) in a vicinity of the end sections thereof and a means for mechanical joining in a mutual manner of these pair-structure support members upon connection, and that a stopper preventing the hoist from approaching an end section of an aerial rail when this means for mechanical joining is not in a condition of effective joining be provided.

It is preferable that the connecting means comprise a means of mechanical connection in a mutual manner of the support-structure support members to be connected and a means both of controlling an operation of this means of mechanical connection and of electrically detecting an effective connection condition of that means of connection, and that a means of control of an operation condition of the stopper in accordance with a detection output of this electrically detecting means be provided.

It is preferable that the electrically detecting means be provided independently in a dual format for each of the pair-structure support members, and that a logical means recognizing the detection output as a valid detection output when both of the dual-format electrically detecting means have an identical detection output be provided.

It is also preferable that a mechanical prevention means preventing the hoist from approaching an end section of a rail when that end section of a rail is not in a position of connection with an opposing end section of a rail be provided at an end section of a rail having the connecting means and independent of both the stopper and the electrically detecting means.

It is preferable that the prevention means be provided at each of a pair of end sections to be mutually connected, and that a mechanical means linking the prevention means of those two end sections be provided.

It is preferable that a means by which the hoist can run under its own propulsion along each of the rails from which the hoist is suspended be provided. A configuration comprising a control end and a means of setting or releasing the synchronizing means in accordance with an operation from that control end can be used. The synchronizing means can comprise an electrical synchronizing means.

A rotating assembly stand rotating about a vertical axis can be used as the conveyor. At this time, the module supply area can be provided separated into a plurality of segments around the rotating assembly stand.

When a rotating assembly stand is used as a conveyor, a configuration wherein the first rail (movable) is disposed so as to be perpendicular to an axis of rotation of the rotating assembly stand, the second rail (fixed) is disposed along a circumference having the axis of rotation at a center thereof, the fourth rails (movable) are disposed along radial straight lines intersecting at that axis of rotation, the third rails (fixed) are disposed along radial straight lines intersecting at that axis of rotation, and the supporting means is disposed having the same center as the second rail can be used.

A configuration comprising a control means enabling passage of the hoist between the fourth rail and the first rail during the setting of a control mode provided so as to rotate or stop the first rail and the fourth rail together in a condition wherein a single straight line is formed, and enabling passage of the hoist between the fourth rail and the third rail during the setting of a control mode provided so as to return the fourth rail to a position whereat a single straight line is formed with the third rail can be used.

In a situation where no fourth rail is provided and the hoist is passed reciprocally between the first rail and the third rail in a direct manner, it is preferable that a control means reading in position information of the first rail and running position information of the hoist and controlling rotation of the first aerial rail and running of the hoist based on these two items of position information be provided. In a case where a rotating assembly stand is being used as the conveyor, a configuration wherein the first rail is disposed so as to be perpendicular to an axis of rotation of the rotating assembly stand, the second rail is disposed along a circumference having the axis of rotation at a center thereof, the third rails are disposed along radial straight lines intersecting at that axis of rotation, and the control means comprises a means of control reading in position information of the rotating assembly stand and linking the rotation of the first rail and the running of the hoist based on three pieces of position items comprising the position information of the rotating assembly stand added to the two items of position information can be used.

A control end is connected to the hoist, and the control means can comprise a means reading in operation information input entered into this control end and controlling the rotation of the first rail and the running of the hoist in accordance with this operation information.

The control means may comprise a means of automatically executing a sequence of operations in accordance with a single “return operation” entered into the control end in a condition wherein the hoist is suspended from the first rail, wherein the sequence of operations comprises:

1) winding up of the hoist,

2) moving of an end of the first rail to a position aligned face-to-face with an end of the third rail whereupon the hoist was located prior to motion thereof to the first rail,

3) connecting of the third rail and the first rail, and

4) moving of the hoist from the first rail to the third rail.

The means of control can comprise a means of rotating the first rail in synchrony with the rotation of the rotating assembly stand in accordance with a “return operation” entered into the control end in a condition wherein the hoist is suspended from the first rail.

It is preferable that the conveyor be a rotating assembly stand rotating about a vertical axis and that at least one control end be disposed in a position allowing operation thereof by a worker on the rotating assembly stand.

It is preferable that the conveyor be a rotating assembly stand rotating about a vertical axis, and that a means of displaying whether or not the first rail is in a state of rotation in synchrony with the rotation of the rotating assembly stand be provided in a position allowing recognition thereof by a worker on the rotating assembly stand.

A partially or fully linear conveyor can be used. In such a case, it is preferable that the module supply area be provided along a portion of the linear conveyor. In a situation where a partially or fully linear conveyor is used, a first rail is provided above this linear portion, and a third rail is provided above the module supply area.

A second aspect of the present invention provides an assembly method for an article having at least one article undergoing an assembly operation on a rotating assembly stand rotating about a vertical axis and supplying a member necessary for assembly of the article from a module supply area provided at a circumference of the rotating assembly stand, wherein that horizontal motion direction delivers onto the rotating assembly stand using a hoist rotating about the vertical axis in synchrony with the rotation of the rotating assembly stand in a space comprising a space above the rotating assembly stand.

The space comprising a space above the rotating assembly stand can be a space above the rotating assembly stand and a portion of a space above the module supply area adjacent to that space.

A third aspect of the present invention provides an assembly method for an article supplying a member necessary for an assembly step of an article for assembly from a module supply area provided in the vicinity of a conveyor while relocating the article for assembly using the conveyor, and performing assembly thereof, comprising a means whereby that member necessary for an assembly step is hoisted up from the module supply area by a hoist, the hoist is moved close to the article to undergo an assembly operation through the running thereof along a rail disposed along the conveyor, and after the hoist has moved close to the article to undergo an assembly operation, a motion direction and a motion speed of the hoist are each controlled so as to be equivalent to a motion direction and a motion speed of the conveyor, and that member is supplied to that article to be subjected to an operation.

A further aspect of the present invention provides a module supply method having a vehicle undergoing an assembly operation disposed on a rotating assembly stand rotating about a vertical axis and supplying a module required for assembly of that vehicle to an assembly operation position of the vehicle from a module preparation area provided at a circumference of that rotating assembly stand using a hoist running on a movable aerial rail provided above the rotating assembly stand, wherein the movable aerial rail is stopped in accordance with an operation and then rotated about an axis common to the vertical axis in synchrony with a speed of rotation of the rotating assembly stand.

The vehicle undergoing an assembly operation can be disposed such that a center line in a longitudinal direction thereof is substantially consistent with a radial direction of the rotating assembly stand.

A further aspect of the present invention provides a vehicle assembly plant providing a rotating assembly stand whereupon a vehicle undergoing an assembly operation is mounted, a plurality of module preparation areas provided in the vicinity of that rotating assembly stand and preparing a module for supply to the rotating assembly stand, and a hoist conveying the module from this module preparation area onto the rotating assembly stand, comprising a fixed aerial rail disposed over the plurality of module preparation areas and a movable aerial rail disposed over the rotating assembly stand, upon which aerial rails the hoist can run, and a means of stopping the movable aerial rail in a condition wherein the hoist can pass between an end section of the fixed aerial rail and an end section of the movable aerial rail.

A further aspect of the present invention provides an aerial rail network comprising a movable aerial rail provided above a workspace and whereupon a hoist can run, a plurality of fixed aerial rails provided in the vicinity of this workspace and whereupon the hoist can run, and a means of connecting an end of this fixed aerial rail and an end of the movable aerial rail so as to enable passage of the hoist, the aerial rail network comprising a control means reading in position information of the movable aerial rail and running position information of the hoist and controlling rotation of the movable aerial rail and running of the hoist based on these two items of position information.

A further aspect of the present invention provides an aerial rail network comprising a plurality of aerial rails whereupon a hoist conveying an article in a suspended condition runs, at least one of the aerial rails being configured so as to be movable, and a connecting means connecting an end section of a fixed aerial rail and an end section of a fixed or movable aerial rail in a condition allowing passage of the hoist in accordance with an operation; wherein the connecting means comprises support members having a pair-type structure and firmly supporting that aerial rail in the vicinity of each of the connectable end sections thereof and a means for mechanical joining in a mutual manner of the pair-structure support members upon connection; the aerial rail network comprising a stopper preventing the hoist from approaching an end section of the aerial rail when the corresponding means for mechanical joining is not in a condition of effective joining.

A further aspect of the present invention provides an aerial rail network comprising a plurality of aerial rails whereupon a hoist conveying an article in a suspended condition runs, at least one of the aerial rails being configured so as to be movable, and a connecting means connecting an end section of a fixed aerial rail and an end section of a fixed or movable aerial rail in a condition allowing passage of the hoist in accordance with an operation; wherein the connecting means comprises support members having a pair-type structure and firmly supporting that aerial rail in the vicinity of each of the connectable end sections thereof and a means for mechanical joining in a mutual manner of the pair-structure support members upon connection; the aerial rail network comprising a first stopper preventing the hoist from approaching an end section of the aerial rail when the corresponding means for mechanical joining is not in a condition of effective joining; wherein the connecting means comprises a means of mechanical connection in a mutual manner of the pair-structure support members to be connected and a means both of controlling an operation of this means of mechanical connection and of electrically detecting an effective connection condition of that means of connection; the aerial rail network comprising a means of controlling an operation condition of the first stopper in accordance with a detection output of this electrically detecting means; and the aerial rail network providing at an end section of an aerial rail having the connecting means, and independent of both the first stopper and the electrically detecting means, a second stopper mechanically preventing the hoist from approaching that end section of an aerial rail when that end section of the aerial rail is not in a position of connection with an opposing end section of an aerial rail.

Effect of the Invention

The present invention was confirmed to be extremely useful through test operation in a step executing assembly of a vehicle using a rotating assembly stand. Results of test operation of the present invention confirmed that, in an operation step providing a module to a vehicle undergoing assembly, a time required for alignment was reduced and other remarkable reductions in man-hours could be achieved. Furthermore, collision of objects under conveyance, article damage, and accidents involving dropping of conveyed articles were eliminated, and other remarkable benefits in terms of operating steps were confirmed.

### BRIEF DESCRIPTION OF DRAWINGS

FIG. 1 shows a conceptual view explaining a rotating assembly stand constituting a first embodiment of the present invention.

FIG. 2 shows a block diagram explaining a control system of a device according to the first embodiment of the present invention.

FIG. 3: A plan view of a rail layout of a device according to the first embodiment of the present invention.

FIG. 4 shows a perspective view illustrating a hoist of a device according to the first embodiment of the present invention.

FIG. 5 shows a plan view explaining a rail suspension structure of a device according to the first embodiment of the present invention.

FIG. 6 shows a perspective view explaining a rail suspension structure of a device according to the first embodiment of the present invention.

FIG. 7 shows a control flowchart explaining a synchronous control of a device according to the first embodiment of the present invention.

FIG. 8 shows a plan view illustrating a rail layout of a device according to a second embodiment of the present invention.

FIG. 9 shows a plan view explaining a rotating assembly stand and aerial rail configuration in the vicinity thereof according to a third embodiment of the present invention.

FIG. 10 shows a flowchart explaining an example of a return control of a device according to the third embodiment of the present invention.

FIG. 11 shows a perspective view (before first stopper connection) of a connection structure of an aerial rail according to a fourth embodiment of the present invention.

FIG. 12 shows a perspective view (after first stopper connection) of a connection structure of an aerial rail.

FIG. 13 shows a plan view (before connection) of a main connection structure of an aerial rail.

FIG. 14 shows a plan view (after connection) of a main connection structure of an aerial rail.

FIG. 15 shows a side view of an aerial rail.

FIG. 16 shows plan view (before second stopper connection) of a connection structure of an aerial rail.

FIG. 17 shows a plan view (after second stopper connection) of a connection structure of an aerial rail.

FIG. 18 shows a front elevation view (before second stopper connection) of a connection structure of an aerial rail.

FIG. 19 shows a front elevation view (after second stopper connection) of a connection structure of an aerial rail.

FIG. 20 shows a front elevation view (after second stopper withdrawal) of a connection structure of an aerial rail.

### DESCRIPTION OF REFERENCE NUMERALS

1. Rotating Assembly Stand
2, 2a-2k. Module Assembly Areas
3. Unloading Opening
4. Sensor
5. Hoist
6. Rail Suspension Jig
7. Control End
8. Motor
9. Sensor
10. Motor
11. First Rail (movable)
12. Second Rail (fixed)
13a-13f. Third Rails (fixed)
14a-14f. Fourth Rails (movable)
15. Fifth Rail (fixed)
16. Sixth Rail (fixed)
17c. Auxiliary Rail (movable)
18. First Stopper
19, 19a. Second Stoppers
21. First Rail (movable)
22a, 22b. Second Rails (fixed)
23. Third Rail (fixed)
24. Fourth Rail (movable)
25. Fifth Rail (fixed)
26. Sixth Rail (fixed)
30. Synchronizing Signal Path
31. Assembly Stand Drive Device
32. Assembly Stand Control Device
33. Control End
34. Crane Drive Device
35. Crane Control Device
41. Piston
42. Connector
43. Connector
44. Boss
45. Drive Motor
46. Fixed Rail
47. Protrusion

### BEST MODE FOR CARRYING OUT THE INVENTION

The present invention is explained in more detail hereinafter by citing practical embodiments.

### Embodiment 1

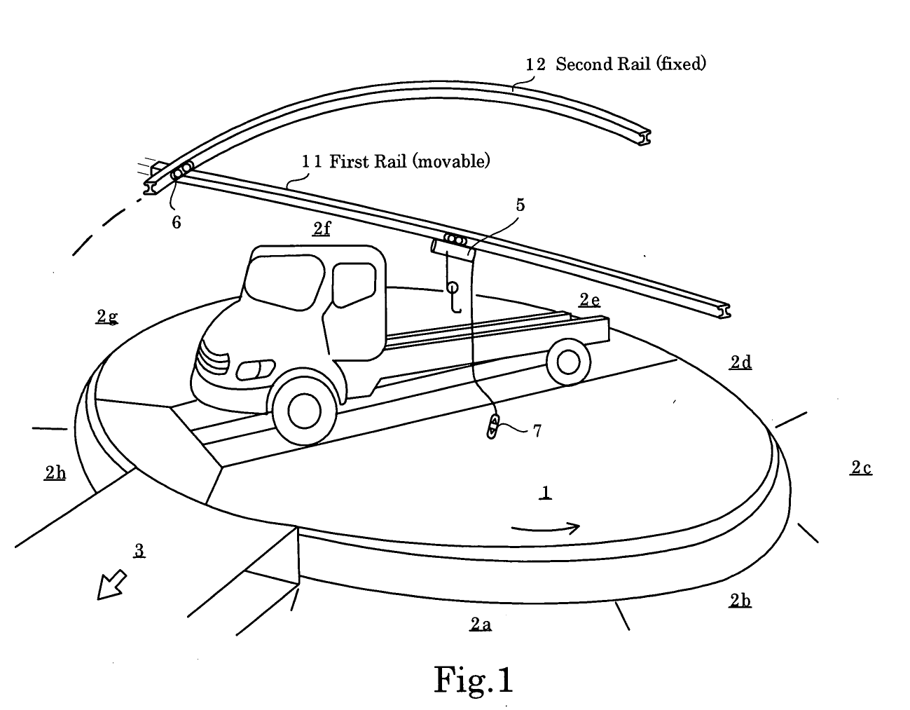

FIG. 1 is a schematic view explaining the main hardware of a device according to an embodiment of the present invention. A vehicle undergoing assembly work is mounted on a rotating assembly stand 1. During the execution of an assembly operation, this rotating assembly stand 1 is slowly rotated in a direction of an arrow shown in the figure by an electric motor provided below this stand. A speed of rotation thereof can be set in a variable manner in accordance with a model and specifications of the assembly vehicle. That speed of rotation is, for example, several degrees per minute, and in more specific terms, is six degrees per minute, for example. By setting to six degrees per minute, this rotating assembly stand 1 rotates once in an hour. In practical terms, it is preferable that this speed of rotation be set in a variable manner. A speed of rotation optimally set in accordance with the model of the vehicle undergoing assembly operations can be set.

A module assembly area 2 preparing a component and a module for supply to this rotating assembly stand 1 is provided at a circumference of the rotating assembly stand 1. Module assembly areas are separated into substantially fan-shaped partitions as shown by the symbols 2a, 2b, 2c, . . . 2h in FIG. 1, and a different module or component is prepared in each area.

The following will explain this in more detail in terms of this embodiment: In a module assembly area 2a, an axle module is prepared and supplied to the rotating assembly stand 1. In a module assembly area 2b, a vehicle frame is assembled, and this is supplied to the rotating assembly stand 1. A large-scale plant fabricating a frame can be disposed at an input-end side of the module assembly area 2b supplying the vehicle frame and can be configured so as to supply frames in regular succession in synchrony with vehicle assembly.

An engine is delivered to a module assembly area 2c from a supply opening outside the figure and prepared in such a format so as to be capable of being loaded into a vehicle, and this is supplied onto the rotating assembly stand 1. In this module assembly area 2c, an operation of mounting necessary components on the delivered engine is carried out.

A plurality of small modules and components are prepared in a module assembly area 2d, and these are supplied onto the rotating assembly stand 1. A cab is prepared in a subsequent module assembly area 2e, located on an opposite side of the vehicle undergoing assembly in FIG. 1 and not appearing in the figure, and this is supplied to the vehicle undergoing assembly operations on the rotating assembly stand 1. Furthermore, a liquid charging area 2e, a hood module assembly area 2f, and a tire and bumper assembly and supply area 2g are provided in a module assembly area on an opposite side of the rotating assembly stand 1.

Devices for inspection and testing are disposed in a final module assembly area 2k on a downstream side of a circumference of the rotating assembly stand 1 in a direction of rotation. Electrical probes and pipes, etc. are connected from these inspection devices to the vehicle undergoing assembly, and testing is carried out on an assembly stand. The vehicle undergoing assembly operations on the rotating assembly stand 1 becomes capable of driving under its own propulsion at this stage, and precisely when the front of the vehicle reaches an unloading opening 3, a driver boards and drives the vehicle so as to exit the rotating assembly stand 1 from the unloading opening 3 under its own propulsion.

Here, a characteristic of the present invention is a crane device used to deliver a component, a module, and a heavy tools, etc. from each module assembly area 2a-2h onto this rotating assembly stand 1 as explained above. In this specification, a crane device is defined as being a device comprising rails 11, 12 provided in a roof space of the plant, a hoist 5 running under its own propulsion on these rails, a control end 7, and other accessories.

The following provides a more detailed explanation: The crane device of the present invention is characterized in that a first rail 11 upon which the hoist 5 runs under its own propulsion is configured so as to be capable of rotating about a rotating axis (a virtual axis) common to a rotating axis of the rotating assembly stand 1, and in addition, is configured such that the rotation of this first rail 11 is synchronized with the rotation of the rotating assembly stand.

The following provides a more concrete explanation by way of reference to FIG. 1: This first rail 11 is suspended through an action of a rail suspension jig 6 so as to be capable of motion with respect to a second rail 12 provided in a fixed manner on a ceiling of the plant. Furthermore, this rail suspension jig 6 is equipped with a motor and a wheel, and an end section of the first rail 11 is configured so as to be capable of moving along the bottom of the second rail 12 in accordance with a operation, or alternatively, in accordance with control of a control device (outside the figure). This rail suspension jig 6 can be easily understood if visualized as an implementation of a top half of the hoist 5, or in other words, a section running under its own propulsion along the rail. Although a front side of a drawing of the first rail 11 shows a cut surface and is not displayed in detail, this front-side end section is also supported in the same way by the second rail 12 so as to be capable of moving through an action of a rail suspension jig. Furthermore, the motor provided in this rail suspension jig 6 is configured such that the first rail 11 is capable of rotating in synchrony with the rotation of the rotating assembly stand 1 in accordance with control from a control circuit outside the figure.

In order to provide more detail, the following will explain a case wherein an engine module is delivered to the rotating assembly stand 1 from the module assembly area 2d, and this is lowered by the hoist 5 and moved to the vicinity of the vehicle undergoing assembly. When a worker operates the control end 7 and lowers the engine module using the hoist 5, an orientation of the first rail 11 is rotated in response to further operation from the control end 7 over an engine mounting position of the vehicle undergoing assembly operations so as to intersect a plane (a virtual plane) including a longitudinal axis of the vehicle. Then, the hoist 5 is run along the first rail 11 and stopped over the engine mounting position. At this time, in the device of the present invention, alignment at an optimum position over the engine mounting position is carried out, and through an operation, the first rail 11 is set to a synchronized rotation condition so as to be rotated in synchrony with the rotation of the rotating assembly stand 1. Following that, the engine module can be accurately lowered to the mounting position of the vehicle by slowing moving a hook of the hoist 5 downward. If a configuration wherein the first rail 11 is set to a synchronized condition were not to be used, displacement between the lowered engine module and a chassis would occur as time passes in accordance with the rotation of the rotating assembly stand 1, and therefore, it would probably be necessary to further fine tune the position of the hoist 5 with respect to the first rail 11 during the course of an operation.

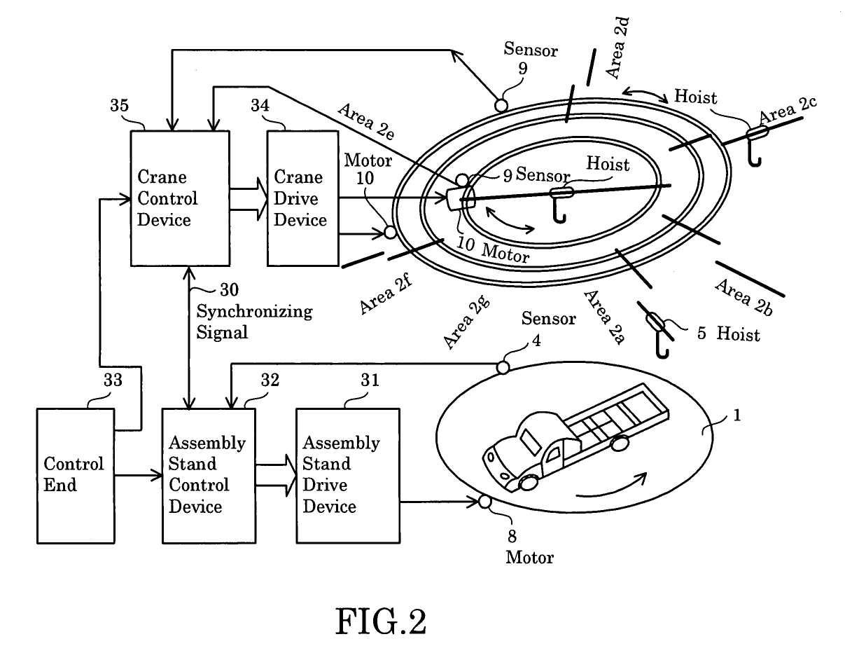

FIG. 2 is a block diagram explaining a drive control system of the device according to an embodiment of the present invention. The rotating assembly stand 1 is driven in rotation by a motor 8. Drive current is supplied to the motor 8 from an assembly stand drive device 31. An angle of rotation of the rotating assembly stand 1 is detected by a sensor 4. A configuration wherein this rotation angle is detected as a relative angle with respect to a standard set as an angle of rotation of the rotating assembly stand 1 is used. The output of this sensor 4 is read into an assembly stand control device 32. The assembly stand control device 22 is subjected to on/off control by an operation output of a control end 33.

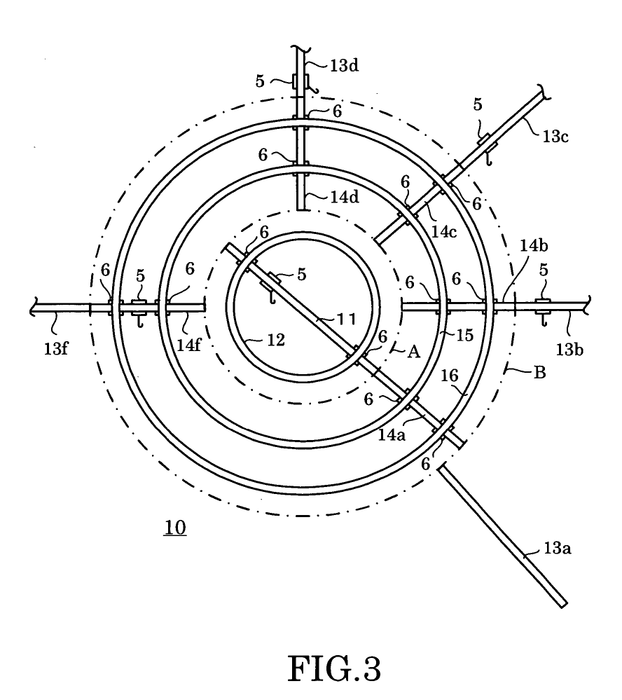

Although the rails were explained in FIG. 1 in terms only of a first rail 11 (movable) and a second rail 12 (fixed), in a practical device, a rail network upon which the hoist 5 runs is configured with a more complex structure in order to be more useful. The structure of this rail network will be explained in more detail later by way of reference to another figure (FIG. 3).

Returning to FIG. 2, this rail network comprises a rail configured so as to be movable as illustrated above using the first rail 11, and a rail configured so as to be fixed in the same way as the second rail 12. A plurality of motors 10 are provided in order to drive those rails configured so as to be movable, and a plurality of sensors 9 are provided in order to detect a current position of those rails configured so as to be movable. Drive current is supplied to each of these motors 10 from a crane drive device 34. An angle of rotation detected by each of the sensors 9 is read into a crane control device 35. The crane control device 35 is controlled by the control end 33. Here, a characteristic of the present invention is the fact that synchronizing signals are mutually communicated between the assembly stand control device and the crane control device, and that drive controls thereof are mutually synchronized. That is to say, the assembly stand control device 32 and the crane control device 35 are connected by an electrical synchronizing signal path 30 shown in FIG. 2.

FIG. 3 is a plan view illustrating a rail device of a crane device according to an embodiment of the present invention. The circumference of the rotating assembly stand as explained above is, in this FIG. 3, substantially equivalent to a circumference illustrated in the form of a second rail (fixed). The first rail 11 (movable) and the second rail (fixed) as explained above are configured in a space above this rotating assembly stand. In a practical device, a more-complex rail network is configured so as to cover the module assembly areas 2 disposed around the rotating assembly stand.

The following will explain FIG. 3 in more detail: Third rails 13a-13f are disposed as fixed rails in a radial pattern and corresponding to each of the module assembly areas 2a-2h explained above. These third rails 13a-13f are provided in a central space above each of the module assembly areas 2a-2h and with an orientation intersecting a vertical line (a virtual line) constituting the central axis of the rotating assembly stand. Furthermore, a rail network for transferring modules in a radial direction is configured between a circle A (a virtual circle) described by a tip of the first rail 11 (movable) and a circle B (also a virtual circle) joining tips of the third rails (fixed). This rail network for transferring modules in a radial travel comprises a pair of annular rings 15, 16 disposed in a fixed manner and a plurality of movable rails 14a, 14f suspended from these annular rings 15, 16, each disposed and set in a radial pattern, and configured so as to be capable of motion in a circumferential direction along these annular rings 15, 16.

An inside tip of these movable rails 14a-14f is configured so as to rotate along the virtual circle A, an outside tip thereof is configured so as to rotate along the virtual circle B, and each can be aligned face-to-face with a tip of the first rail 11 or of the third rails 13a-13f. For example, a tip of the fourth rail 14d (movable) at the top of FIG. 3 is aligned face-to-face with an end of the third rail 13d (fixed), and the hoist 5 suspended from the third rail 13d (fixed) can pass to the fourth rail 14d (movable) via this alignment position. That is to say, the hoist 5 hoists up a module in this module assembly area and this passes to the fourth rail 14d; furthermore, the first rail 11 (movable) is rotated, and this hoist 5 can be delivered to the first rail 11 (movable) on the circle A.

The reason why these fourth rails 14a-14f (movable) are configured so as to be movable with respect to a fifth rail 15 (fixed) and a sixth rail 16 (fixed) is so that, even in cases where an operation on the rotating assembly stand does not necessarily proceed in line with a set time, leeway within the corresponding duration can be allowed for. That is to say, in the event of a situation likely to lead to an operation on the rotating assembly stand exceeding a scheduled time, a module required in the next process cannot be delivered to the rotating assembly stand at an appropriate time. At this time, by moving the fourth rails 14a-14k (movable) slightly towards a downstream side, delayed pick-up can be carried out. By moving towards a rotation upstream side in a situation where the progress of a step is faster than scheduled and a module required by a next step is required slightly early, early pick-up can be carried out. Furthermore, an operation wherein the hoist 5 from which the module is suspended remains for some time on the fourth rails 14a-14k (movable) is also possible. This is useful in situations where a discrepancy in timing occurs between a module supply side and an assembly execution side. That is to say, even in the event of situations where assembly operations do not proceed as designed, the configuration of the present invention can compensate and minimize an effect on others.

The module assembly area 2e is an area for supply of liquids, and since there is no requirement for articles to be conveyed using a hoist, this area is not provided with a radial-pattern rail (third rail). The same applies to an area supplying a tire or an area wherein inspection is performed, and these are not provided with a radial-pattern rail (third rail).

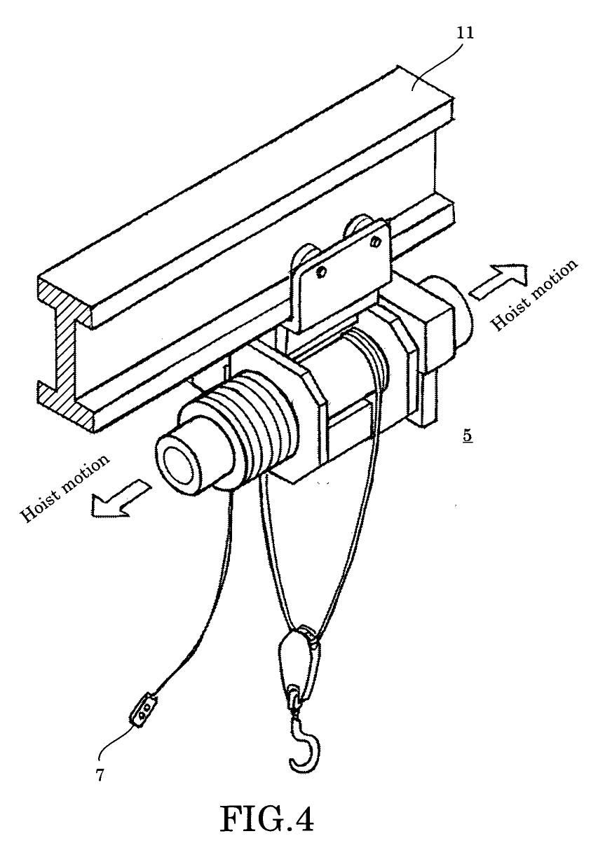

FIG. 4 is a perspective view explaining a construction of the hoist 5 running along the rail 11. As a result of the execution of an operation from the control end 7, this hoist 5 moves as shown by an arrow along the rail 11, and also as a result of the execution of an operation from the control end 7, this hoist can raise and lower a hook thereof in a direction of an arrow. This construction is widely known, and therefore, a more detailed explanation is omitted.

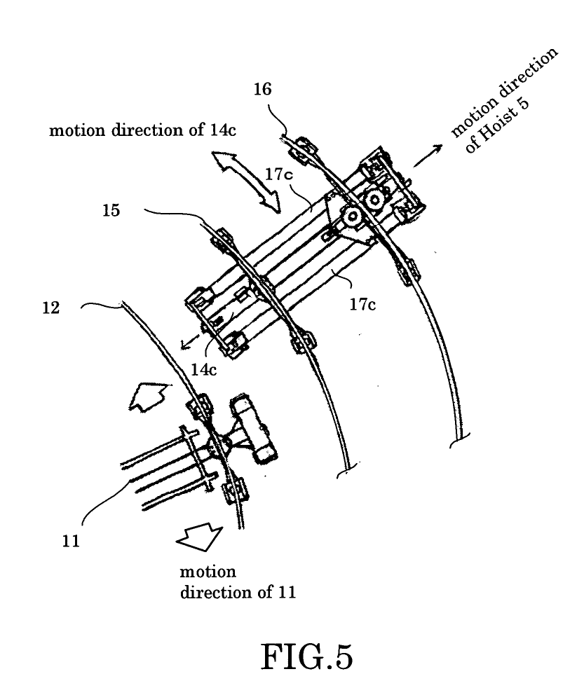

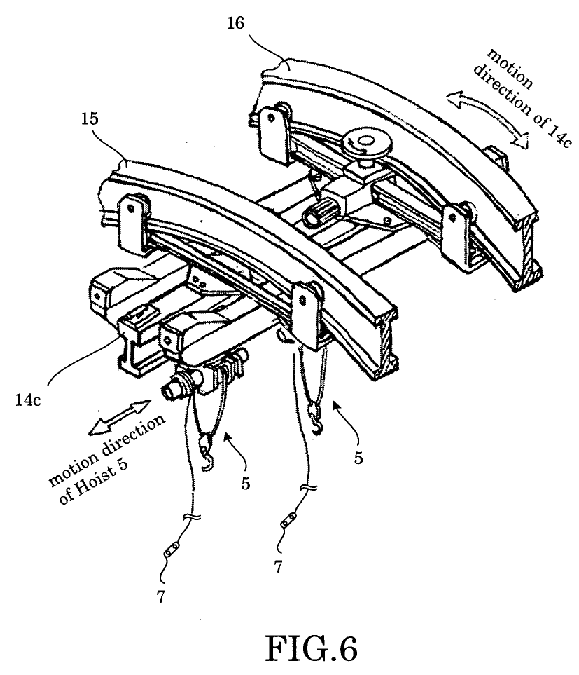

FIG. 5 and FIG. 6 are figures explaining a construction wherein the fifth rail 15 and the sixth rail 16 are assembled to the fourth rail 14 (movable). FIG. 5 is a plan view seen from above the rails, and FIG. 6 is a perspective view. The fourth rail 14c is supported by a pair of auxiliary rails 17c disposed in parallel, and this pair of auxiliary rails 17c is supported so as to be suspended from the circular fixed rails 15, 16. As a result of this, the rail 14c can, together with the auxiliary rails 17c, rotate along the circular-shaped fixed rails 15, 16 while an axial direction thereof is correctly maintained in a radial direction.

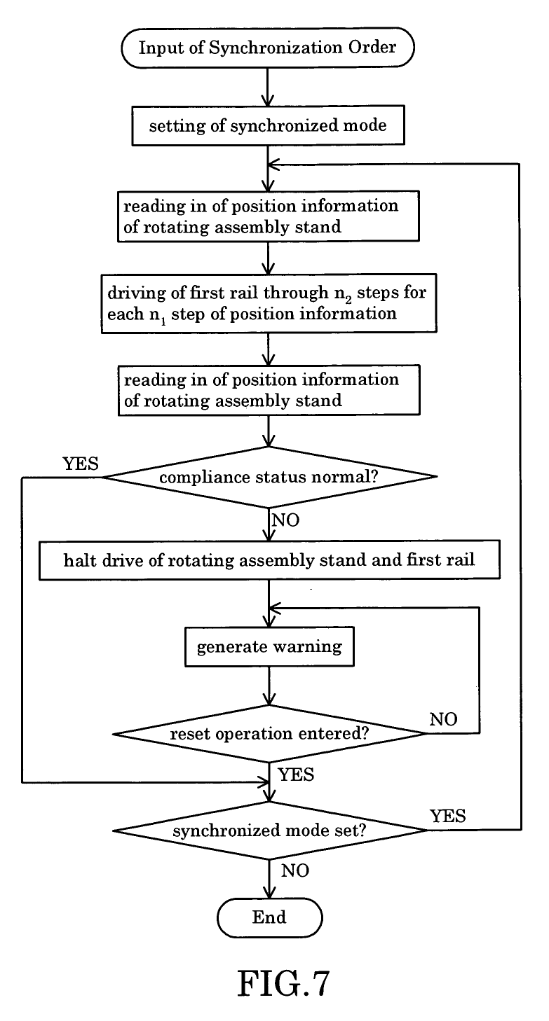

FIG. 7 illustrates, in terms of a device according to an embodiment of the present invention, the main parts of a software configuration for synchronizing the rotation of the rotating assembly stand and the rotation of the first rail 11 supporting the hoist 5. Synchronized mode is set when a synchronized condition is ordered by way of an operation. Position information relating both to rotation of the rotating assembly stand 1 and to rotation of the first rail is read in, and a synchronized condition is set. A synchronous compliance status is thereafter monitored, and as long as no abnormalities occur, the synchronized condition is maintained. If a synchronous abnormality occurs, a warning is generated and a reset operation is requested.

The crane device illustrated in FIG. 3 or FIG. 2 is not limited to having a single hoist 5 running on a rail, and is illustrated utilizing a plurality of hoists 5 within a plurality of rail networks. The number of hoists used can be selected and set for each of a plurality of module assembly areas so as to be convenient in terms of utilization of this crane device. Technology for controlling hoists so as not to collide or interfere with each other in a configuration wherein a plurality of hoists run on a single crane device is also well know in terms of crane devices, and therefore, a more detailed explanation is omitted.

An electrical power line and a signal line are each wired to an aerial rail on which a hoist runs, and a hoist running on this aerial rail uses a current collecting device to receive a current from this power line and a signal current from this signal line. Power and a signal current are provided from a wire suspended from the ceiling of the plant to the power line and the signal line, respectively. Power and a signal current are also provided from a wire suspended from the ceiling of the plant to a movable aerial rail. That wire suspended from the roof is formed with a spiral shape and configured so as to be free of problems even if a reasonable amount of twisting should occur. A construction supplying power and a signal current to this movable device is a well known technology, and furthermore, these devices are catalog products and can be purchased together with a hoist. Accordingly, a detailed explanation is omitted. Furthermore, wireless methods of control using electromagnetic waves or light are also known in terms of communication of signals with respect to the hoist. Although this type of wireless-method technology can be used in whole or in part the apparatus of the present invention, the significance thereof with respect to the gist of the present invention as disclosed herein is small, and therefore, a detailed explanation is omitted.

### Embodiment 2

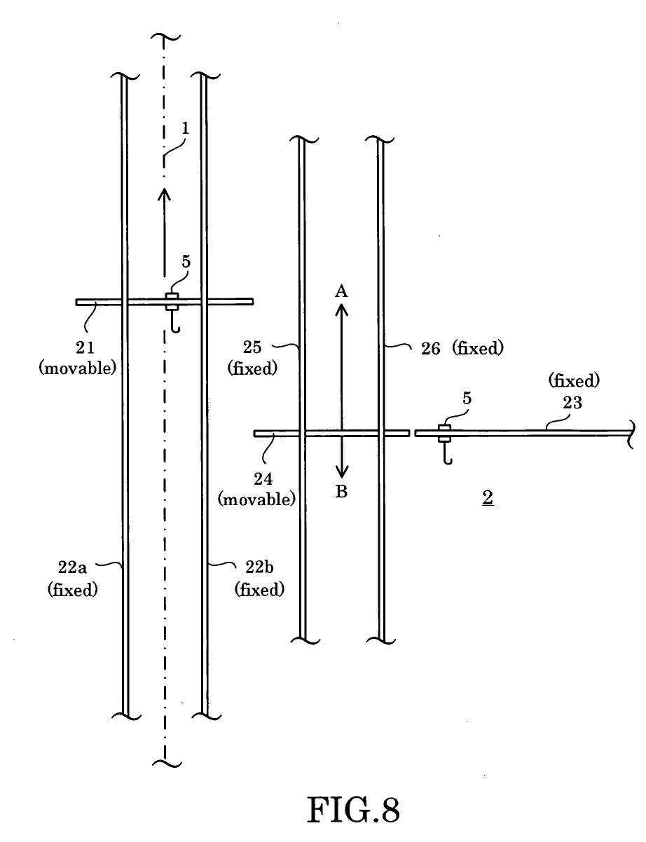

FIG. 8 is a plan view illustrating a rail layout according to a second embodiment of the present invention. An article to be subject to assembly and manufacture is conveyed by a conveyor 1 shown by a chain single-dashed line at the left of the figure. The conveyor 1 is disposed on a plant floor surface, and during operation of a plant, this conveyor 1 conveys an article at a constant speed in a direction shown by an arrow. Furthermore, components are successively added and mounted, etc. by accessing that article from a lateral direction, and a degree of completion of the article as a product successively increases. That is to say, the degree of completion of the article increases in accordance with relocation thereof by the conveyor in a direction of an arrow shown in the figure. Configuration areas similar to that shown in FIG. 8 are provided repeatedly at the bottom and the top of this figure, and as a single article to be subjected to assembly and manufacture passes through this plurality of areas, the degree of completion thereof increases.

A pair of fixed second rails 22a, 22b parallel to the conveyor 1 is equipped in a space above this conveyor 1. Furthermore, a movable first rail 21 is suspended from these second rails 22a, 22b. This first rail 21 is directly above the conveyor 1, and a longitudinal direction thereof is perpendicular (90□) to a direction of motion of the conveyor 1. This first rail 21 is configured so as to be moved by a drive device (not shown) along the second rails 22a, 22b at a speed equal, in principle, to a relocation speed of the conveyor 1.

Meanwhile, a module to be supplied to the article to be subjected to assembly and manufacture on that floor surface is prepared in a module supply area 2. Furthermore, a fixed third rail 23 is provided above this module supply area 2. A height of this third rail 23 from the floor surface is set so as to be equivalent to a height of the first rail 21 (movable) from the floor surface. This third rail 23 is formed with a configuration allowing a hoist 5 to be suspended. That is to say, although the third rail 23 is a fixed rail, a cross-section construction thereof is formed with a shape equivalent to that of the first rail 21.

A fifth rail 25 and a sixth rail 26 are disposed parallel to the second rails 22a, 22b in a space between this module supply area 2 and the conveyor 1. A height of this fifth rail 25 and sixth rail 26 from the floor surface is equivalent to that of the second rails 22a, 22b. A movable fourth rail 24 is suspended from this fifth rail 25 and sixth rail 26. A construction of this fourth rail 24 is equivalent to a construction of the first rail 21 and is configured so as to be capable of moving in a longitudinal direction thereof along the pair of fixed rails constituted by the fifth rail 25 and the sixth rail 26. A direction of motion of this fourth rail 24 corresponds to Arrow A or B. Furthermore, this fourth rail 24 is also formed with a construction allowing a hoist 5 to be suspended. That is to say, a cross-section construction of this fourth rail is equivalent to a cross-section construction of the first rail 21. The hoist suspended from the fourth rail 24 is not shown in FIG. 8.

A procedure using a device assembled with a construction of this kind to convey a module prepared in the module supply area 2 to an article to be subject to assembly and in motion along the conveyor 1 is explained hereinafter: The module prepared on the floor surface of the module supply area 2 is hoisted therein using the hoist 5. Next, the fourth rail 24 (movable rail) is moved to a position forming a single straight line with the third rail 23 (fixed rail) from which that hoist 5 is suspended. Next, the hoist 5 hoisting the module is run and passed to the fourth rail 24. Next, the fourth rail 24, having received the hoist, is moved in a direction of Arrow A, and this is set so as to form a single straight line with the first rail 21. At this time, this fourth rail 24 moves at a speed equivalent to that of the first rail 21.

In this condition, the hoist 5 is moved from the fourth rail 24 to the first rail 21. Next, through operation of this hoist 5 in an independent manner, the conveyed module can be supplied to a desired position of the article to be subject to assembly and in motion along the conveyor 1. At this time, since the module 5 is synchronized with the conveyor and in a condition of motion in an equivalent direction and with an equivalent speed, the module can be accurately moved close to the article to be assembled, being either latched to or mounted on the conveyor 1. An inconvenience such as collision between the conveyed module and the article to be assembled does not occur.

After the module conveyed by this hoist 5 has been passed to the article to be assembled and moving on the conveyor 1, the hoist 5 synchronizes and is returned to the moving fourth rail 24. Furthermore, the synchronized condition of the fourth rail 24 with respect to the first rail 21 is released, and by moving the fourth rail 24 in a direction of Figure B in the figure, it can go to receive a next module being newly prepared in the module supply area 2.

The configuration illustrated in FIG. 8 is a single step section supplying a module from a single module supply area 2. By providing a configuration similar to the configuration shown in FIG. 8 a plurality n times repetitively along the conveyor 1, a manufacturing line having n steps along the conveyor 1 is formed.

### Embodiment 3

The above embodiment explained an example of implementation of the present invention using a triple aerial-rail construction. This triple aerial-rail construction is flexible in terms of conveyance and is suitable for the execution of an assembly step for vehicles having various models. However, it was determined that a vehicle assembly step can also be executed using a simpler aerial-rail construction. For example, it was confirmed that a triple aerial-rail construction need not necessarily be used if the models manufactured at that vehicle assembly plant are limited to some degree or if an operation step sequence or a format of a module to be prepared is further improved. The erection of a double aerial-rail construction instead of the triple aerial-rail construction is to be undertaken in the vehicle assembly plant implemented next.

In general, the simpler the device construction, the lower the price, and in addition, there are also fewer malfunctions. Accordingly, a double aerial-rail construction has fewer structural elements than a triple aerial-rail construction, and naturally, the cost of erection thereof and the number of malfunctions can be expected to be low. Furthermore, control thereof can also be expected to become simpler. Such an embodiment is illustrated hereinafter.

Although implemented using a method and device illustrated in FIG. 1, this embodiment differs from the first embodiment in that a configuration of an aerial rail on which the hoist 5 runs has been simplified. That is to say, although another movable aerial rail for passing of a hoist is provided at a position between an aerial rail 11 above the rotating assembly stand and the aerial rails 13a-13b in a space above a module preparation area in the first embodiment, this embodiment is characterized in that a movable aerial rail provided in this intermediate position is discontinued.

Furthermore, an aerial rail configuration of a device according to an embodiment of the present invention is explained hereinafter by way of reference to FIG. 2. FIG. 2 is a plan view of an aerial rail according to an embodiment of the present invention. Circular or straight-lines shapes displayed using a solid line are aerial rails. A movable aerial rail 11 is movably suspended in the vicinity of both ends thereof from a fixed aerial rail 12 set up with a circular shape. A circular section illustrated in FIG. 2 by a chain single-dashed line is approximately the area of the rotating assembly stand 1. The moving aerial rail 11 and the fixed aerial rail 12 are set up at a height of approximately 3 meters above a plant floor surface. The moving aerial rail 11, while maintaining a position so as to be oriented in a radial direction of a circle formed by the fixed aerial rail 12, can run so as to rotate along this fixed aerial rail 12. In this, a position thereof can be changed either clockwise or counter-clockwise as shown by an arrow in accordance with control or an operation.

The hoist 5 is suspended from this moving aerial rail 11 and can run in a longitudinal direction of this moving aerial rail 11. The hoist 5 can also run on the fixed aerial rails 13a-13f in a longitudinal direction thereof. A necessary number of hoists 5 can be provided within this aerial rail network.

Next, in an aerial rail network of this format, if the moving aerial rail 11 is rotated and stopped, for example, at a position whereat an end section thereof becomes aligned face-to-face with the fixed aerial rail 13a, the hoist 5 can pass through that alignment position in both directions between the moving aerial rail 11 and the fixed aerial rail 13a. The hoist can also move in both directions with respect to the other fixed aerial rails 13b-13f.

The most practical construction is configured such that, in addition to stopping at a position whereat end sections are aligned face-to-face, a means for mechanically connecting, having a mechanically strong construction between the two aerial rails and capable of joining and releasing in accordance with an operation, is operated when the hoist 5 passes through this alignment position. The connecting construction of the two aerial rails where through the hoist passes can be provided with a strong structure in accordance with a weight of the hoist and a maximum weight conveyed by the hoist. A detailed explanation thereof is not a main subject of the present invention and is, therefore, omitted.

As an example, an operation of supplying an engine module using this hoist 5 from a module preparation area 2c to a vehicle undergoing an assembly operation is explained hereinafter. A vehicle undergoing assembly work is disposed on the rotating assembly stand 1. The rotating assembly stand 1 rotates slowly about a vertically-oriented central axis thereof. At this time, furthermore, an assembly operation is underway on the rotating assembly stand 1 using a axle module already delivered from a module preparation area 2a, a vehicle frame already delivered from a module preparation area 2b, and the like. At a point in time at which an engine module is delivered from a module preparation area 2c, a front direction of this vehicle undergoing an operation has approximately reached a position of a module preparation area 2c. At this time, a worker controls the moving aerial rail 11 and performs rotation thereof along the fixed aerial rail 12, and one tip of the moving aerial rail 11 is stopped precisely at a face-to-face alignment position corresponding to a tip of the fixed aerial rail 13c. The worker performs an operation to mechanically connect a tip of the fixed aerial rail 13c and a tip of the moving aerial rail 11.

At this time, an engine module completed to a predetermined level is suspended from the hoist 5 running on the fixed aerial rail 13c and is in a standby condition. Next, a worker operates this hoist so as to run along the fixed aerial rail 13c and pass from the fixed aerial rail 13c to the moving aerial rail 11. After confirming that the hoist 5 has duly moved to the moving aerial rail 11, the mechanical connection is released. Next, the hoist 5 on this moving aerial rail 11 is moved to the vicinity of an engine mounting position of the vehicle undergoing an operation. Simultaneous thereto (or almost simultaneous thereto), a position of the moving aerial rail 11 with respect to the fixed aerial rail 12 is finely adjusted and changed through an operation. When the moving aerial rail 11 reaches a position almost parallel to a longitudinal direction of a vehicle undergoing an assembly operation, a mode a rotation direction and a rotation speed of the moving aerial rail 11 is synchronized with a rotation direction and a rotation speed of the rotating assembly stand 1 is established through a further operation.

As a result thereof, a condition of the engine module suspended from the hoist 5 is such that a position thereof with respect to the vehicle undergoing an assembly operation on the rotating assembly stand 1 does not change. In this condition, the engine module can be accurately moved close to a mounting position thereof on the vehicle undergoing an assembly operation by finely adjusting a motion position of the hoist 5 with respect to the aerial rail 11 and a length of a suspension wire of the hoist 5. More specifically, a mounting opening formed on the engine module and a mounting opening on the vehicle are aligned, and a bolt is passed through both of these openings.

An item similar to the control system of the first embodiment displayed in FIG. 3 can be used as a control system controlling a device according to this embodiment. Furthermore, the control flowchart shown in FIG. 7 can be implemented in order to control a position of the aerial rail 11 so as to be synchronized with a rotation of the rotating assembly stand 1.

Next, a return operation of the hoist, constituting another characteristic of a device according to the present invention is explained hereinafter. As explained above, modules are delivered from one of the module preparation areas 2a-2f onto the rotating assembly stand 1 using the hoist 5 while a worker provides assistance. When that module is lowered to a predetermined position of the vehicle undergoing an assembly operation, that hoist becomes no longer necessary. This hoist must be returned to the original position thereof.

Although it is preferable that this be carried out by executing operations similar to those performed upon module delivery in a reverse sequence, a worker should, without becoming involved with this type of operation, concentrate on an operation required for mounting of that module on the vehicle. A device according to an embodiment of the present invention is configured such that, in response to the entering of “Return” on the control end 7 connected to the hoist 5, this is executed using automatic program control. A “Return” button is provided on the control end 7 in a device according to an embodiment of the present invention. This control program, launched in response to an operation of this “Return”, is implemented in a control device 35 as a means for controlling.

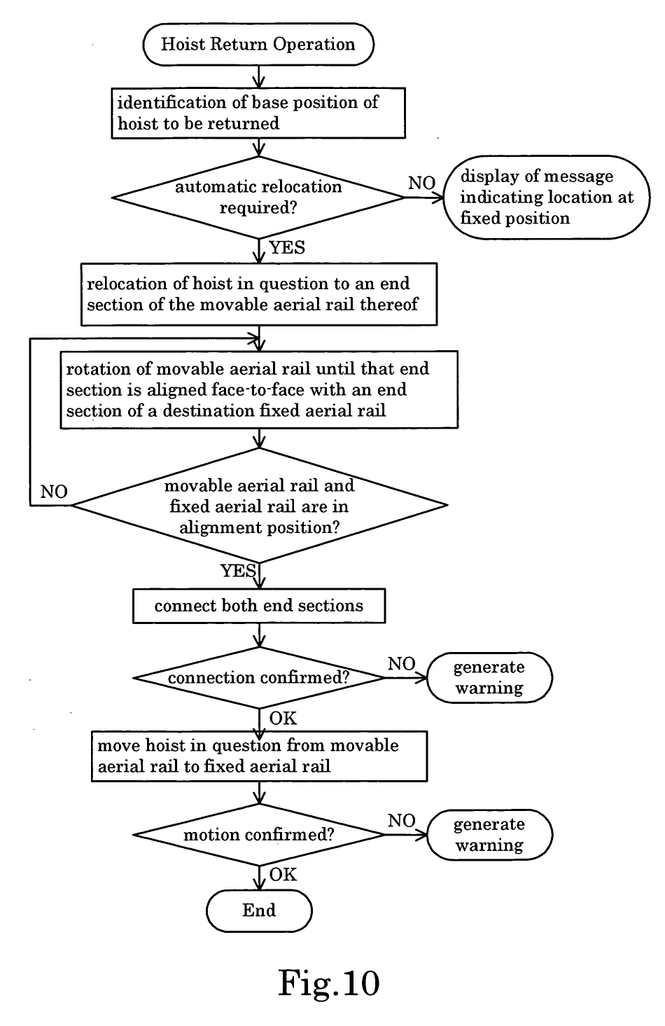

FIG. 10 is a control flowchart explaining a configuration of this program. That is to say, when a worker on the rotating assembly stand 1 unloads a necessary item of equipment from the hoist 5, the worker enters a return operation on the control end 7 connected to that hoist 5. As a result of this, the controlling means identifies an identification signal sent from that hoist, and by referencing a control history corresponding to that identification signal, identifies a base position of that hoist. If the base position of that hoist is on a different rail and a requirement for automatic relocation is recognized, the hoist to be relocated is moved to an end section of that moving aerial rail 11. Simultaneous thereto, the moving aerial rail 11 is rotated until that end section becomes aligned face-to-face with an end section of a destination fixed aerial rail (one of 13a-13f). When this moving aerial rail 11 and the fixed aerial rail (one of 13a-13f) reach a position of face-to-face alignment, the end sections of both thereof are connected. When connection is confirmed, that hoist 5 is moved from the moving aerial rail 11 to the fixed aerial rail (one of 13a-13f). When this motion is confirmed, control for this purpose is ended. In a case wherein connection is not confirmed or a case wherein motion is not confirmed, etc., an abnormal situation exists or assistance of a worker is required, and a warning is generated accordingly.

Although the base position of the hoist to be returned is identified from the control history thereof in the above explanation, the base position of that hoist can also be identified using a different method. For example, a base position can be set in a fixed manner to each hoist in advance, and a table matching each hoist identification signal with base position information can be set up in the control device 35. Then, when a return operation is carried out, the controlling means refers to this table based on the identification signal of the hoist for which this return operation was carried out and identifies the position whereto return should be carried out. If that position is on a different rail, a configuration can be set up so as to execute each operation for the purpose of return.

In this way, the construction of an aerial rail in this embodiment is simpler and more uncomplicated that the construction illustrated in the first and second embodiment. As a result of this, a floor surface area of a vehicle assembly plant can be made smaller, and a more economic vehicle assembly plant and method thereof can be provided. In accordance with this embodiment, an easily controlled aerial-rail construction, having a lower price and fewer malfunctions than the first and second embodiments, and an operation method thereof can be realized.

### Embodiment 4

When an end section of an aerial rail is in a separated condition in the above embodiments, even if a hoist running on that aerial rail were to run to the vicinity of the point of separation of the aerial rail, that hoist must not fall from the end section of that aerial rail. Furthermore, when an aerial rail is in a connected condition with another aerial rail, a hoist from which an article of a maximum allowable weight is suspended must be able to run smoothly through that connection point. In addition, it was confirmed that a maximum allowable weight for conveyance must be further increased from that of conventionally installed aerial rails and hoists, and that equipment of a scale capable of conveying an engine module of a large vehicle is required.

A running operation of a hoist is carried out in accordance with a state of progress of an operation and, in principle, in response to a switch operation of a worker. Accordingly, when an end section of an aerial rail is in a separated condition, it is necessary that running of the hoist be stopped automatically before the end section, even if a switch operation were to be carried out erroneously. Furthermore, when an end section of an aerial rail is in a connected condition with an end section of another aerial rail, it is necessary that the hoist be run through that connection point with the tips of the two rails mutually connected in a sturdy manner and fully capable of bearing the weight thereof.

If this were to depend solely on visual confirmation by a worker, it is believed that errors in an operation could occur. In certain cases when performing an operation of conveying an article using a hoist, confirmation of whether or not the tips of the two aerial rails positioned overhead are mutually connected in a suitable manner is not possible from a position of a worker performing that operation. Accordingly, even if an erroneous operation were a possibility, the hoist must not be moved to the vicinity of the end sections of non-connected aerial rails. Furthermore, a hoist from which a heavy article is suspended must not pass between two aerial rails appearing to be connected but not connected in a sturdy manner. In addition, consideration must be given to the fact that, even if a switch operation is performed correctly, malfunction wherein an operation of the hoist is, as a result of a factor of some manner, inconsistent with that operation is also a possibility.

In that kind of situation, it is necessary to forcibly stop running of the hoist before dropping thereof from the aerial rail on which it is running. In that case, simply shutting of the power required for running as a means for forcible stopping is not necessarily sufficient for the purpose of safety, and it is preferable that a condition wherein running of the hoist is mechanically impossible be realized. Furthermore, when the tips of the two aerial rails are in a state of connection, a suitably sturdy mechanical means for reliably maintaining the connected state is needed in order that a hoist from which an article of the maximum allowable weight is suspended be able to pass smoothly through that connection point.

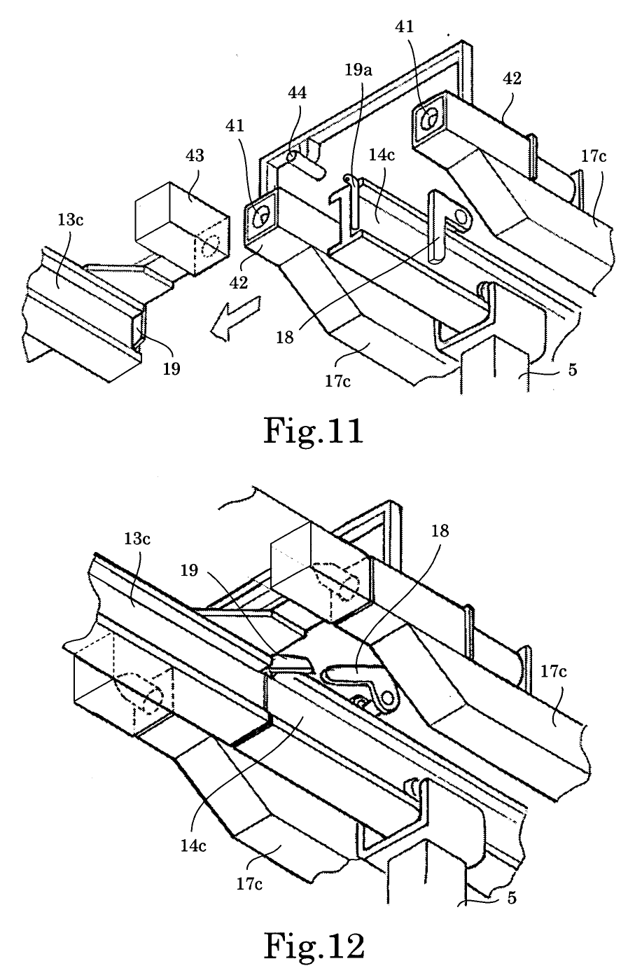

An embodiment resolving this type of issue is explained hereinafter by way of reference to figures. FIG. 11 and FIG. 12 are perspective views showing the main parts of a connection device according to this embodiment. FIG. 3 to FIG. 20 are diagrams illustrating this embodiment in terms of a stopper constituting this connection device and safety device.

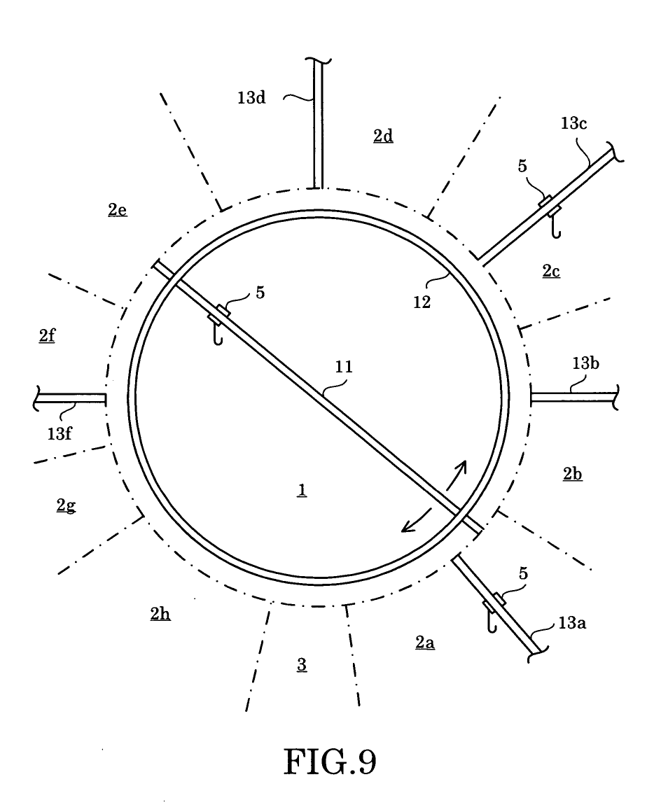

This embodiment relates to a safe construction for passing a hoist in a sure and reliable manner between movable aerial rails or between a movable aerial rail and a fixed aerial rail in the aerial rail network presented in FIG. 3, FIG. 8, or FIG. 9. Furthermore, this embodiment provides a construction forcibly prohibiting this passage between a movable aerial rail and another aerial rail or a fixed rail when a rail has not achieved a state capable of passing in a sure and reliable manner and the hoist attempts to pass through the connection point thereof.

As shown in FIG. 11, a connector 42 is provided at each end section of a pair of auxiliary rails 17c supporting a movable aerial rail 14c from both sides. As the aerial rail 14c is capable of connection at both longitudinal-direction ends thereof, a pair of these connectors 42 is provided at each end, for a total of four; however, a construction thereof is shown only in terms of an outside end in this FIG. 11. Similarly, a connector 43 corresponding to this is also provided on a fixed aerial rail 13c. A piston 41 is housed in the connector 42, and a cylinder-shaped opening matching a shape of a piston tip and engaging when this piston has protruded is provided in the connector 43.

Furthermore, when forming a state of connection, this piston 41 is capable of being projected by an electrical mechanism from the connector 42 towards a connection partner. That is to say, when the movable aerial rail 14c moves in a direction of an arrow shown in FIG. 11 and stops at a correct position whereat connection is possible as shown in FIG. 12, the connector 42 operates and that piston 41 projects. A tip of this piston 41 engages with an opening of the connector 43, provided as a match on the opposing aerial rail 13c. Since the piston 41 does not proceed any further following correct engagement with the opening of the opposing connector 43, an electric circuit detects this and transmits an electric signal indicating correct connection.

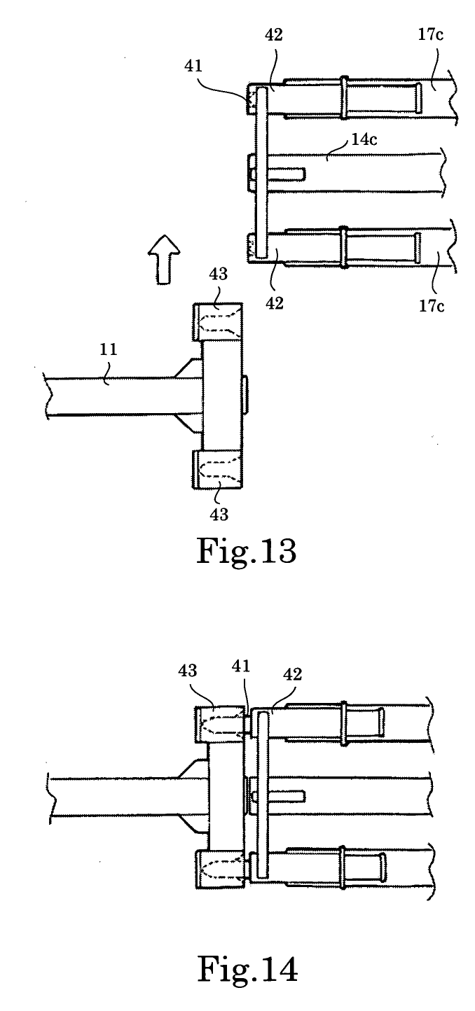

FIG. 13 and FIG. 14 are embodiment plan views illustrating a condition of connection with the movable aerial rail 14c when a movable aerial rail has moved thereto. FIG. 13 shows a condition before connection, and the piston 41 is housed within the connector 42. FIG. 14 shows a condition after connection. As shown in FIG. 14, when the relative positioning of the two rails reaches a connection position, the piston is projected from the connector 42 and inserted into a hollow opening in the opposing connector 43. As a result of this, the condition of connection is maintained firmly. That is to say, this embodiment is constructed such that no direct mutual connection is made between aerial rails on which the hoist 5 runs, that support members supporting those aerial rails are provided, and that a connector is provided on those members. In the example shown in this FIG. 13 and FIG. 14, the auxiliary rail 17c constitutes one of these support members.

When the piston 41 projects from the connector 42 with respect to the opposing connector 43 and stops at a correct connection position as explained above, a connection completion signal is transmitted and a stopper is released. If a situation were to arise wherein the positions of the connector 42 and the connector 43 are mutually displaced and the piston 41 of the connector 42 does not fully project or does fully project but overshoots the correct connection position, a correct condition of connection would not be achieved and the connection completion signal would not be transmitted; however, as shown in a figure, the tip of the piston 41 can engage with and enter the opening in the connector 43 as a result of a projection force thereof, even when a slight mutual displacement exists in the positions of the connector 42 and the connector 43, and therefore, this type of failure in completing connection does not occur.

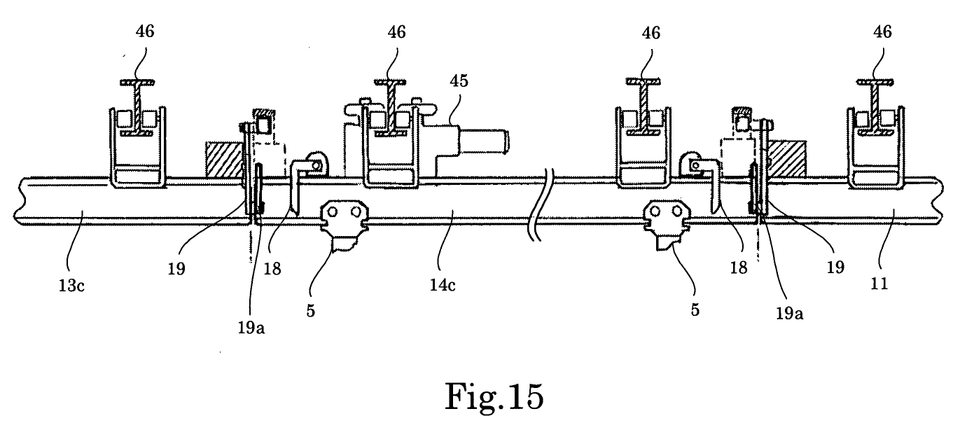

FIG. 15 is a side view illustrating a construction by which a fixed rail is supported on a plant ceiling and a connection construction. This figure shows a condition wherein one end section of the movable rail 14c has reached a position of connection with the fixed rail 13c, and in addition, another end section is at a position of connection with a movable rail 11 provided above a rotating assembly stand. Each of these moving and fixed rails is supported by a fixed rail 46 securely mounted on a ceiling of the plant so as to be capable of moving or be fixed, respectively. The movable rail 14c is configured so as to be capable of being driven with respect to one of these fixed rails 46 by a drive motor 45. Incidentally, in a condition shown in this FIG. 15, the condition of mutual connection between those aerial rails remains at a point before completion of a connection operation thereof, and a first stopper 18 is in a state blocking running of the hoist 5.

Returning to FIG. 11, the first stopper 18 is provided in the vicinity of an end section of the moving aerial rail 14c. This is of a mechanically strong construction, and even if the hoist 5 runs thereto in motion towards this end section of the overhead rail 14c, the hoist 5 is physically blocked from passing that position when this first stopper 18 is in a blocking position as shown in FIG. 11. That is to say, a rotating axis of this first stopper 18 is configured so as to be rotated about an axis perpendicular to an electric motor through an action of that electric motor and a helical gear (worm gear) installed on a rotating axis of that electric motor. As explained above, when the overhead rail 14c and the overhead rail 13c are positioned with a straight-line shape and the connector 42 is correctly connected the connector 41, an electric signal indicating correct connection is transmitted by the electric circuit. The electric motor rotates in response to this electric signal, an as shown in FIG. 12, this first stopper 18 is rotated to a raised position. As a result of this, the hoist 5 located on the aerial rail 14c can pass without obstruction to the aerial rail 13c. In a case wherein an electric signal indicating correct connection is not transmitted, the hoist having run along the aerial rail 13c makes contact with the first stopper 18, and the first stopper 18 physically blocks passage of the hoist 5. In other words, since a helical gear is provided between this first stopper and a drive motor thereof as explained above, even if the hoist 5 attempts passage, the force thereof acts in an axial direction of the motor and the stopper 18 is not lifted as result of an impact thereof.

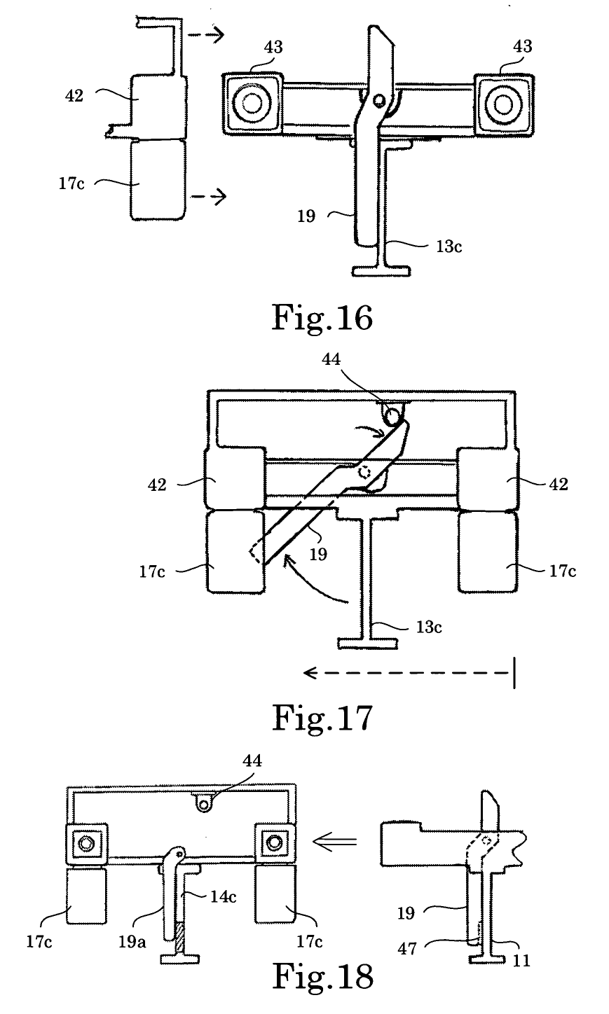

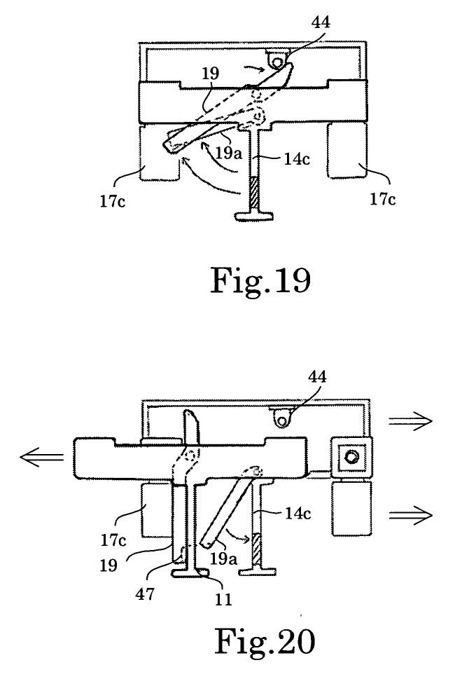

In this embodiment, a second stopper is also provided in addition to the first stopper in order to further increase safety. FIG. 16 and FIG. 19 are views for the purpose of explaining a construction of the second stopper. FIG. 16 is a front elevation showing the fixed aerial rail 13c and the connector 43 mounted thereon as seen from a connection surface thereof (movable aerial rail 14c side). A second stopper 19 is a metal fitting pivotally mounted and supported between a pair of connectors 43 on a side of the fixed aerial rail 13c so as to be capable of rotating freely about a longitudinal-direction axis of a first rail 11. In a condition shown in FIG. 16, a hoist running (in a direction perpendicular to a paper surface) on the aerial rail 13c is blocked by the second stopper 19 at this position and cannot reach the connection position.

As shown by a dotted-line arrow in FIG. 16, the connector 42 moves relatively in a direction of the connector 43, and when this reaches a position shown in FIG. 17, a boss 44 provided on a connector 42 side comes into contact with an upper-edge neighborhood of this metal fitting. The boss 44 can also be seen in FIG. 11. As the drawing in FIG. 11 would without doubt become complicated, only a section of the second stopper 19 with which this boss 44 comes into contact is drawn. Now, returning to FIG. 16, this second stopper is rotated about an axis thereof in this condition, and the hoist running on the aerial rail 13c becomes able to pass through this position.

In this way, the second stopper 19 is configured so as to be raised only when the connector 42 is precisely at a position whereat connection with the connector 43 is possible. That is to say, when a position of the auxiliary rail 17c moves as shown by a broken-line arrow in FIG. 17 to a position whereat connection with the corresponding aerial rail 13c is disassociated, the second stopper 19 returns automatically to a position shown in FIG. 16 under the weight thereof. No drive force whatsoever of a motor, etc. is supplied to this second stopper 19. This constitutes one characteristic of this embodiment. Passage of the hoist through an end section of the aerial rail 13c at this connection position is permitted only when the connectors 42, 43 are actually at a position whereat connection is possible and in response to a relative movement of a movable aerial rail. Electrical signals etc. are of absolutely no concern in terms of this operation, and even during interruption of plant power, operation is effective.

A construction further expanding a function of the second stopper in order to improve safety is explained hereinafter by way of reference to FIG. 18, FIG. 19, and FIG. 20. This is a construction of a second stopper, disposed on an end section of the movable aerial rail 11 on the rotating assembly stand and the movable aerial rail 14c, and configured such that a second stopper is provided on each of a pair of aerial rails that can be connected and these two second stoppers are operated in a coupled manner. That is to say, a second stopper 19a shown in FIG. 18 has a construction automatically set in a blocking position under the weight thereof in the same way as the second stopper 19 explained above. However, a section of this second stopper 19a above a rotating axis thereof is of a short length, and the second stopper 19a is not configured so as to rise in response to a relative motion of an aerial rail as a result of contract with the boss 44.

This second stopper 19a is configured so as to be raised in a coupled manner with a second stopper 19 disposed at an end section of the opposing moving aerial rail 11 for connection when the second stopper 19 is at a raising position.

That is to say, a tip of the second stopper 19 has a small protrusion 47 facing outwards as shown in FIG. 18. Furthermore, this protrusion 47 is configured so as to engage with the second stopper 19 of the opposing side for connection. When the second stopper 19 makes contact with the boss 44 and is raised in a direction of an arrow as shown in FIG. 19, an opposing second stopper 19a is raised in a coupled manner. In a condition wherein the positions of the two aerial rails 11, 14c are displaced relatively as shown in FIG. 20, this condition of engagement is released and the second stopper 19a returns automatically to an original position under the weight thereof.

It should be noted that a construction having duplicate second stoppers is also provided between the movable aerial rail 14 and an outer-side fixed aerial rail 13, and this point is indicated in FIG. 1 in the form of the second stopper 19a of the movable aerial rail 14c and the second stopper 19 of the fixed aerial rail 13c.

With regard also to the construction having duplicate second stoppers, no special drive force whatsoever must be supplied in order to drive or return these second stoppers, and a second stopper operates automatically in response to relative positions of two aerial rails. In accordance with this construction, regardless of a position of a hoist on an aerial rail, the hoist can be prevented from dropping from an unconnected end section, even in the case of a power interruption condition wherein electrical devices are completely unable to operate.

It should be noted that the second stopper displayed in FIG. 18 to FIG. 20 can be provided on the fixed aerial rail 13c and the movable aerial rail 14c in place of the second stopper of FIG. 16 and FIG. 17.

Although the above explanation was based on a example of usage of a triple aerial-rail construction on a rotating assembly stand, similar usage is also possible in a straight-line type movable rail network as presented in the second embodiment, and in addition, similar usage is also possible in a double aerial-rail construction as presented in the third embodiment. Not only in a vehicle assembly plant, furthermore, this embodiment can be similarly utilized in all kinds of aerial rail construction of a format wherein a movable aerial frame is temporarily connected and passing of a hoist is carried out.

In accordance with this embodiment, an inconvenience such as falling of a hoist from an aerial-rail end section and an aerial-rail connection section can be prevented in principle, even if an error is made in an operation or an electrical or mechanical control operation becomes confused due to an unexpected factor of some manner, and even if an interruption of power occurs. The present invention can improve the safety of an operation. By improving the safety of an operation, a duration of halting of an operation as a result of a malfunction can be eliminated or reduced, and a productivity rate can be increased.

### INDUSTRIAL APPLICABILITY

As of the submission of the present application, test implementation of the present invention has only just started; however, an extremely favorable condition has been confirmed. As new problem points have been identified, more improvements will probably be made. The construction according to the present invention can be widely implemented in mass-production plants and is not restricted to automobile assembly plants.

1. An assembly plant comprising a conveyor conveying an article undergoing an assembly operation, a module assembly area supplying a module to the article being conveyed by this conveyor, and a hoist transporting the module to be supplied from this module supply area along the conveyor to a position of the article in motion, wherein:
a direction of motion and a speed of the hoist above the conveyor is synchronized with a direction of motion and a speed of the article conveyed by the conveyor.

2. The assembly plant of claim 1, comprising, as the synchronizing means, a first rail wherefrom the hoist provided above the conveyor is suspended and capable of moving that hoist in synchrony with a motion of that conveyor and a fixed second rail supporting this first rail so as to be movable.

3. The assembly plant of claim 2, comprising a third rail capable of passing the hoist reciprocally between the first rail provided in a fixed manner above the module supply area and the third rail and a connecting means connecting the first rail and the third rail in a condition allowing passage of the hoist therebetween.

4. The assembly plant of claim 3, wherein the connecting means comprises a fourth rail capable of mutually passing the hoist between the first rail and the fourth rail and between the third rail and the fourth rail and a supporting means supporting this fourth rail so as to be movable in a space between the first rail and the third rail.

5. The assembly plant of claim 3, wherein the connecting means comprises a means for stopping the first rail in a condition wherein an end section of the first rail opposes an end section of the third rail so as to enable the hoist to pass reciprocally and directly between the first rail and the third rail.

6. The assembly plant of claim 5, wherein the means for stopping comprises a mechanical means of connection between an end section of the first rail and an end section of the third rail.

7. The assembly plant of claim 4, wherein:
the means of connection comprises support members having a pair-type structure and firmly supporting each of a pair of rails having mutually opposing end sections in a vicinity of the end sections thereof and a means for mechanical joining in a mutual manner of these pair-structure support members upon connection;
the assembly plant comprising a stopper preventing the hoist from approaching an end section of an aerial rail when this means for mechanical joining is not in a condition of effective joining.

8. The assembly plant of claim 7, wherein:
the connecting means comprises a means of mechanical connection in a mutual manner of the pair-type structure support members to be connected and a means both of controlling an operation of this means of mechanical connection and of electrically detecting an effective connection condition of that means of connection;
the assembly plant comprising a means of control of an operation condition of the stopper in accordance with a detection output of this electrically detecting means.

9. The assembly plant of claim 8, wherein the electrically detecting means is provided independently in a dual format for each of the pair-structure support members, the assembly plant comprising a logical means recognizing the detection output as a valid detection output when both of the dual-format electrically detecting means have an identical detection output.

10. The assembly plant of claim 8, comprising, at an end section of a rail having the connecting means, and independent of both the stopper and the electrically detecting means, a mechanical prevention means preventing the hoist from approaching that end section of a rail when that end section of a rail is not in a position of connection with an opposing end section of a rail.

11. The assembly plant of claim 10, wherein the prevention means is provided at each of a pair of end sections to be mutually connected, the assembly plant comprising a mechanical means linking the prevention means of those two end sections.

12. The assembly plant of claim 1, comprising a means whereby the hoist can run under its own propulsion along each of the rails from which the hoist is suspended.

13. The assembly plant of claim 1, comprising a control end and a means of setting or releasing the synchronizing means in accordance with an operation from that control end.

14. The assembly plant of claim 1, wherein the synchronizing means comprises an electrical synchronizing means.

15. The assembly plant of claim 1, wherein the conveyor is a rotating assembly stand rotating about a vertical axis.

16. The assembly plant of claim 15, wherein the module supply area is separated into a plurality of segments around the rotating assembly stand.

17. The assembly plant of claim 4, wherein the conveyor is a rotating assembly stand rotating about a single vertical axis, the first rail (11, movable) is disposed so as to be perpendicular to an axis of rotation of the rotating assembly stand, the second rail (12, fixed) is disposed along a circumference having the axis of rotation at a center thereof, the fourth rails (13a-13f, movable) are disposed along radial straight lines intersecting at that axis of rotation, the third rails (13a-13f, fixed) are disposed along radial straight lines intersecting at that axis of rotation, and the supporting means (15, 16) are disposed having the same center as the second rail (12).

18. The assembly plant of claim 17, comprising a control means enabling passage of the hoist (5) between the fourth rail (one of 13a-13f) and the first rail (11) during the setting of a control mode provided so as to rotate or stop the first rail and the fourth rail together in a condition wherein a single straight line is formed, and enabling passage of the hoist (5) between the fourth rail (one of 13a-13k) and the third rail (one of 13a-13f) during the setting of a control mode provided so as to return the fourth rail to a position whereat a single straight line is formed with the third rail.

19. The assembly plant of claim 5, comprising a control means reading in position information of the first rail and running position information of the hoist and controlling rotation of the first aerial rail and running of the hoist based on these two items of position information.

20. The assembly plant of claim 19, wherein:
the conveyor is a rotating assembly stand rotating about a vertical axis, the first rail is disposed so as to be perpendicular to an axis of rotation of the rotating assembly stand, the second rail is disposed along a circumference having the axis of rotation at a center thereof, the third rails are disposed along radial straight lines intersecting at that axis of rotation; and
the control means comprises a means of control reading in position information of the rotating assembly stand and linking the rotation of the first rail and the running of the hoist based on three pieces of position items comprising the position information of the rotating assembly stand added to the two items of position information.

21. The assembly plant of claim 19, wherein:
a control end is connected to the hoist; and
the control means comprises a means reading in operation information input entered into this control end and controlling the rotation of the first rail and the running of the hoist in accordance with this operation information.

22. The assembly plant of claim 21, wherein:
the control means comprises a means of automatically executing a sequence of operations in accordance with a single “return operation” entered into the control end in a condition wherein the hoist is suspended from the first rail, the sequence of operations comprising:
1) winding up of the hoist;
2) moving of an end of the first rail to a position aligned face-to-face with an end of the third rail whereupon the hoist was located prior to motion thereof to the first rail;
3) connecting of the third rail and the first rail; and
4) moving of the hoist from the first rail to the third rail.

23. The assembly plant of claim 22, wherein the control means comprises a means of rotating that first rail in synchrony with the rotation of the rotating assembly stand in accordance with a “return operation” entered into the control end in a condition wherein the hoist is suspended from the first rail.

24. The assembly plant of claim 2, wherein:
the conveyor is a rotating assembly stand rotating about a vertical axis; and
at least one control end is disposed in a position allowing operation thereof by a worker on the rotating assembly stand.

25. The assembly plant of claim 2, wherein the conveyor is a rotating assembly stand rotating about a vertical axis, the assembly plant comprising a means of displaying whether or not the first rail is in a state of rotation in synchrony with the rotation of the rotating assembly stand provided in a position allowing recognition thereof by a worker on the rotating assembly stand.

26. The assembly plant of claim 1, wherein the article undergoing an assembly operation is a vehicle.

27. The assembly plant of claim 1, wherein all or a portion of the conveyor is linear.

28. The assembly plant of claim 27, wherein the module supply area is provided along a linear portion of the conveyor.

29. The assembly plant of claim 3, wherein:
all or a portion of the conveyor is linear; and
a first rail (21) is provided above this linear portion and a third rail (24) is provided above the module supply area (2).

30. An assembly method for an article having at least one article undergoing an assembly operation on a rotating assembly stand rotating about a vertical axis and supplying a member necessary for assembly of the article from a module supply area provided at a circumference of the rotating assembly stand, wherein:
that horizontal motion direction delivers onto the rotating assembly stand using a hoist rotating about the vertical axis in synchrony with the rotation of the rotating assembly stand in a space comprising a space above the rotating assembly stand.

31. The assembly method for an article of claim 30, wherein the space comprising a space above the rotating assembly stand is a space above the rotating assembly stand and a portion of a space above the module supply area adjacent to that space.

32. An assembly method for an article supplying a member necessary for an assembly step of an article for assembly from a module supply area provided in the vicinity of a conveyor while relocating the article for assembly using the conveyor, and performing assembly thereof; comprising:
a means whereby that member necessary for an assembly step is hoisted up from the module supply area by a hoist, the hoist is moved close to the article to undergo an assembly operation through the running thereof along a rail disposed along the conveyor, and after the hoist has moved close to the article to undergo an assembly operation, a motion direction and a motion speed of the hoist are each controlled so as to be equivalent to a motion direction and a motion speed of the conveyor, and that member is supplied to that article to be subjected to an operation.

33. A module supply method having a vehicle undergoing an assembly operation disposed on a rotating assembly stand rotating about a vertical axis and supplying a module required for assembly of that vehicle to an assembly operation position of the vehicle from a module preparation area provided at a circumference of that rotating assembly stand using a hoist running on a movable aerial rail provided above the rotating assembly stand, wherein:
the movable aerial rail is stopped in accordance with an operation and then rotated about an axis common to the vertical axis in synchrony with a speed of rotation of the rotating assembly stand.

34. The module supply method of claim 33, wherein the vehicle undergoing an assembly operation is disposed such that a center line in a longitudinal direction thereof is substantially consistent with a radial direction of the rotating assembly stand.

35. A vehicle assembly plant providing a rotating assembly stand whereupon a vehicle undergoing an assembly operation is mounted, a plurality of module preparation areas provided in the vicinity of that rotating assembly stand and preparing a module for supply to the rotating assembly stand, and a hoist conveying the module from this module preparation area onto the rotating assembly stand, comprising:
a fixed aerial rail disposed over the plurality of module preparation areas and a movable aerial rail disposed over the rotating assembly stand, upon which aerial rails the hoist can run, and a means of stopping the movable aerial rail in a condition wherein the hoist can pass between an end section of the fixed aerial rail and an end section of the movable aerial rail.

36. An aerial rail network providing a movable aerial rail above a workspace and whereupon a hoist can run, a plurality of fixed aerial rails in the vicinity of this workspace and whereupon the hoist can run, and a means of connecting an end of this fixed aerial rail and an end of the movable aerial rail so as to enable passage of the hoist, comprising:
a control means reading in position information of the movable aerial rail and running position information of the hoist and controlling rotation of the movable aerial rail and running of the hoist based on these two items of position information.

37. The aerial rail network of claim 36, wherein:
the workspace is a rotating assembly stand; and
the control means comprises a means of control reading in position information of the rotating assembly stand and linking the rotation of the movable aerial rail and the running of the hoist based on three pieces of position items comprising the position information of the rotating assembly stand added to the two items of position information.

38. The aerial rail network of claim 36, wherein:
a control end is connected to the hoist; and
the control means comprises a means reading in operation information input entered into this control end and controlling the rotation of the movable aerial rail and the running of the hoist in accordance with this operation information.

39. The aerial rail network of claim 38, wherein:
the control means comprises a means of automatically executing a sequence of operations in accordance with a single “return operation” entered into the control end in a condition wherein the hoist is suspended from the movable aerial rail, the sequence of operations comprising:
1) winding up of the hoist;
2) moving of an end of the movable aerial rail to a position aligned face-to-face with an end of the fixed aerial rail whereupon the hoist was located prior to motion thereof to that movable aerial rail;
3) connecting of the fixed aerial rail and the movable aerial rail; and
4) moving of the hoist from the movable aerial rail to the fixed aerial rail.

40. The aerial rail network of claim 38, wherein the control means comprises a means of rotating that movable aerial rail in synchrony with the rotation of the rotating assembly stand in accordance with a “return operation” entered into the control end in a condition wherein the hoist is suspended from the movable aerial rail.

41. An aerial rail network comprising a plurality of aerial rails whereupon a hoist conveying an article in a suspended condition runs, at least one of the aerial rails being configured so as to be movable, and a connecting means connecting an end section of a fixed aerial rail and an end section of a fixed or movable aerial rail in a condition allowing passage of the hoist in accordance with an operation, wherein:
the connecting means comprises support members having a pair-type structure and firmly supporting that aerial rail in the vicinity of each of the connectable end sections thereof and a means for mechanical joining in a mutual manner of the pair-structure support members upon connection; and
a stopper preventing the hoist from approaching an end section of the aerial rail when the corresponding means for mechanical joining is not in a condition of effective joining is provided.

42. The aerial rail network of claim 41, wherein the pair-structure support members are a pair of auxiliary rails supporting a corresponding movable rail substantially along the entire length thereof.

43. The aerial rail network of claim 41, wherein:
the connecting means comprises a means of mechanical connection in a mutual manner of each of the pair-structure support members to be connected and a means both of controlling an operation of this means of mechanical connection and of electrically detecting an effective connection condition of that means of connection; and
a means of controlling an operation condition of the first stopper in accordance with a detection output of this electrically detecting means is provided.

44. The aerial rail network of claim 43, wherein the electrically detecting means is provided independently in a dual format for each of the pair-structure support members, the aerial rail network comprising a logical means recognizing the detection output as a valid detection output when both of the dual-format electrically detecting means have an identical detection output.

45. An aerial rail network comprising a plurality of aerial rails whereupon a hoist conveying an article in a suspended condition runs, at least one of the aerial rails being configured so as to be movable, and a connecting means connecting an end section of a fixed aerial rail and an end section of a fixed or movable aerial rail in a condition allowing passage of the hoist in accordance with an operation, wherein:
the connecting means comprises support members having a pair-type structure and firmly supporting that aerial rail in the vicinity of each of the connectable end sections thereof and a means for mechanical joining in a mutual manner of the pair-structure support members upon connection;
a first stopper preventing the hoist from approaching an end section of the aerial rail when the corresponding means for mechanical joining is not in a condition of effective joining is provided;
the connecting means comprises a means of mechanical connection in a mutual manner of the pair-structure support members to be connected and a means both of controlling an operation of this means of mechanical connection and of electrically detecting an effective connection condition of that means of connection;
a means of controlling an operation condition of the first stopper in accordance with a detection output of this electrically detecting means is provided; and
a second stopper mechanically preventing the hoist from approaching that end section of the aerial rail when that end section of an aerial rail is not in a position of connection with an opposing end section of an aerial rail is provided at an end section of an aerial rail having the connecting means and independent of both the first stopper and the electrically detecting means.

46. The aerial rail network of claim 45, wherein the second stopper is provided at each of a pair of end sections to be mutually connected, the assembly plant comprising a means of mechanically linking the second stoppers of those two end sections.
